(19) United States
(12) Patent Application Publication
(10) Pub. No.: US 2007/0250295 A1
(43) Pub. Date: Oct. 25, 2007

(54) Multidimensional modeling system and related method

(75) Inventors: Peter M. Murray, Freeport, ME (US); Christopher Houle, Cape Elizabeth, ME (US); Michael Salisbury, Freeport, ME (US); Brian Cabana, Westbrook, ME (US)

Correspondence Address: CHRIS A. CASEIRO, VERRILL DANA, LLP, ONE PORTLAND SQUARE, PORTLAND, ME, 04112-0586, US

(73) Assignee: Subx, Inc., Portland, ME (US)

(21) Appl. No.: 11/393,361

(22) Filed: Mar. 30, 2006

(51) Int. Cl. G06F 17/10

(52) U.S. Cl. 703/2

(57) ABSTRACT

A computer-enabled system and related method to perform multi-dimensional modeling. The system includes a model building function, a data link function, a dependency inspector function and a presentation function. The system unlocks the connectivity between model logic, model structure and outcome presentation. Model cells are given understandable names, and the system allows parsing and reorganization of model information without loss of logic, including formulas associated with cell elements. The data link function enables a user to insert into a matrix of the system external information of an array of data types. The dependency inspector function enables a user to quickly and easily identify relationships among cell elements. This capability reduces the time required to detect modeling errors, to audit the model, and/or understand logical relationships embodied in the model.

### BACKGROUND OF THE INVENTION

1. Field of the Invention

The present invention relates to modeling systems and methods. More particularly, the present invention relates to systems and methods for convenient manipulation of complex models. Still more particularly, the present invention relates to modeling systems and methods involving multidimensional data groupings.

2. Background Description

Information in the form of data is important in a broad array of applications, but only to the extent that the information can be managed in an organized way. From healthcare to financial services and a wide range of other fields, ever increasing reliance is placed on gathering information, storing that information, and manipulating it to explain events that have occurred or to plan for future events. For example, a business owner may wish not only to determine sales information on a macro level, but also to determine where and when sales occur and the dependency of those sales on steps undertaken, such as pricing discounts, advertising, etc. However, the information gathered for that purpose can overwhelm and lead to confusion rather than understanding.

Electronic databases have been employed to help store, organize and access gathered information. Databases come in many forms including proprietary, commercial and ad hoc types. They range widely in complexity as a function of the information gathered and the information of interest. Databases are limited not only by their potential for complexity and access difficulties, but by the fact that they do not aid the user in manipulating, or adding logic to, the stored information. That is, the information may be stored and viewed but it cannot be subjected to calculations useful in explaining the importance of that information.

Spreadsheets resolve this limitation associated with databases. Spreadsheets not only provide a mechanism to enable information storage, organization and access, they also provide the user with a way to subject that information to manipulation through selectable and creatable equations. For that reason, spreadsheets in the form of computer programs are used to model the importance of information. That is, they are used to manipulate information to produce outcomes, either to explain past outcomes or to predict future outcomes. In the case of the business owner, a past outcome may be a decline in sales in one region of the country, while a future outcome may be the expected impact on sales in that same region as a result of advertising increases in that region. Needless to say, there are many situations in which there is an interest in understanding a past outcome or a possible future outcome.

The advantage of outcome understanding through information manipulation using spreadsheets is widely known. However, as the volume of information gathered to insert into a spreadsheet expands, and the number of relationships of interest among various information sets increases, the manipulation complexity increases. Unfortunately, spreadsheets are only two-dimensional and so the difficulties experienced in dealing with complex relationships and calculations are magnified. As a result, those having the skill to perform the manipulations effectively may be a small group in relation to the size of the group interested in the outcomes. Moreover, complexity tends to increase the likelihood that errors will occur, whether in the selection of information used in an equation, the equation itself, or the selection of information set relationships. In a two-dimensional modeling environment it becomes difficult to detect where a particular error exists as the size of the information set and/or the number of equations increases.

The two-dimensional commercial spreadsheet programs currently available and used to model outcomes are of limited functionality as the information set and/or desired or required number of manipulations increases. Attempts to reduce complexity typically involve breaking up the manipulation project into modules comprising multiple two-dimensional spreadsheets. For example, one information set may be inserted into one worksheet of a spreadsheet, subjected to one or more equations to produce a set of outcomes. The set of outcomes from that worksheet may be manually inserted into another worksheet with other sets of outcomes or information and that set subjected to one or more equations. This may continue for a large iterative number of worksheets. At some point, the number of two-dimensional worksheets can become unwieldy and the relationship from a given cell of a particular worksheet to one or more cells of one or more other worksheets may be lost. In particular, if there is an interest or need to understand the relationship, it must be re-discovered through manual examination.

An additional limitation on currently available commercial spreadsheet computing programs used to model outcomes involves the form of the information manipulated. It is not uncommon to have an interest in manipulating information (data) in varied forms to produce an outcome. If the data are not of a common form, they must be converted to the common form manually before manipulation. For example, data from a Java-based source may have to be combined with data from a Windows-based source. This limitation on data form further reduces the usefulness of existing spreadsheet programs, particularly as the number of variables to consider increases in a manipulation and as variations in information form expand. Additionally, the user of the spreadsheet program must have substantial technical skills to perform manipulations on information embodied in a plurality of forms.

Existing two-dimensional spreadsheet programs are useful in relatively simple modeling situations, provided the information used in the modeling is of a standardized form. However, they become much more difficult to use as the desired range of outcomes and the information forms expand. Therefore, what is need is a modeling system and method configured to allow an understanding of relationships across information sets. What is also needed is a modeling system and method configured to incorporate information of differing types without requiring manual standardization of the information. Further, what is needed is a modeling system and method suitable for use by a broad range of individuals.

### SUMMARY OF THE INVENTION

It is an object of the present invention to provide a modeling system and corresponding method configured to allow an understanding of relationships across information sets. It is also an object of the present invention to provide a modeling system and corresponding method configured to incorporate information of differing types without requiring manual standardization of the information. Further, it is an object of the present invention to provide a modeling system and corresponding method suitable for use by a broad range of individuals.

These and other objects are achieved in the present invention, which is a multi-dimensional modeling system and corresponding method configured to enable any user to gather and store information and perform manipulations on that information to produce outcomes.

The system and corresponding method are computer based and enable a user to perform multi-dimensional modeling in an understandable manner. As with any modeling system, the present invention has a system architecture including a logic aspect, a structure aspect and a presentation aspect. The logic aspect includes item (individual cell) descriptors, formula language and the relationships between the two. The structure aspect includes the setup of the model for presentation and calculations. That is for example, what types of items or groups of items are on the x-axis and what type are on the y-axis. The presentation aspect is the view observed by the user as the model is developed. Prior modeling systems have the same aspects. However, unlike prior modeling systems, the logic, structure and presentation aspects of the modeling system of the present invention are unlinked or separated from one another. As a result, the present invention enables the user to adjust one or more features of one aspect without disrupting the ability to make adjustments to the other aspects. As a specific example, a user may develop an initial model including a set of data that is the subject to a set of calculations to produce a set of outcomes made visible on a display as one or more multi-dimensional matrices. The user may adjust the presentation to produce a different view of any one or more matrices. The structural aspect of the formulary relations with designated data items remains in tact without adjustment by the user. Further, the logic aspect of the formula/item relationships will also remain in tact for subsequent modification, if desired, without affecting the ability to go back and adjust the presentation or structure aspect of the model. On the other hand, in a traditional two-dimensional spreadsheet, a user wishing to change a chart display would be required to change item locations within cells and reconfigure formula relationships.

The system of the present invention employs ordinary language and understandable computational relationships in assigning or determining characteristics of each element (cell) of the model. This transparent logic of the modeling system renders it easier for the user to manage. The system includes a model building function with a multi-dimensional calculation engine, a data integration function, a data link function, a dependency inspector function and a presentation function. Model cells are given understandable names, and the system allows parsing and reorganization of model information without loss of logic, including formulas associated with cell items. The architecture of the system allows for seamless modification of any aspect of the model created without starting over as would be required in a traditional two-dimensional modeler. The data link function enables a user to insert into a matrix of the system external information of differing data types. The dependency inspector function enables a user to quickly and easily identify relationships among cell elements. This capability reduces the time required to detect modeling errors.

In an embodiment of the invention, a system is provided for multi-dimensional modeling of one or more outcomes based on input information on a computer system including a display. The model building function is arranged to generate a matrix containing the input information and calculated information, wherein the calculated information is obtained using one or more formulas, assumptions, and/or input information. The matrix includes a plurality of dimensions of cells of input information and calculated information. The use of understandable and unique names of items and left side/right side formulas results in the ability to produce highly scalable models. The model building function includes a calculation engine with formulas and formula syntaxes arranged such that swaths of items may be calculated using a single formula, rather than requiring a one-to-one relationship of cell to formula. This collapses the total number of formulas required, making for an easier to understand model and one that may be highly scalable and extendible. That is, item changes may be made without requiring complete formula rewrites, and large sets of calculated items may be achieved with vast numbers of formulas.

The data link function is arranged to configure external information into a selectable format for introduction into the matrix and selectable calculation of calculated information therefrom. The data link function includes a source configuration subfunction to configure the external information into a selectable type, and a destination configuration subfunction to configure the matrix into a selectable type for entering the configured external information. The selectable type of the source configuration subfunction may be selected from a group including a delimited text file, a JDBC data source, an ODBC data source, a two-dimensional matrix of data, web services, SOAP, and XML data source, but not limited thereto. The selectable type of the destination configuration subfunction may be selected from the group including a two-dimensional matrix and a multidimensional matrix, but not limited thereto.

The presentation function is arranged to display on the display of the computer system the matrix, and further arranged to enable a user to manipulate the appearance of the matrix on the display. The unlinking characteristic of the architecture of the system enables the user to do so without disruption of logic and/or structure. The presentation function includes the optional feature of permitting a user to select view of one or more matrices created in arrangements of selectable sets of categories. The user may select a set of items to be presented and show only that set. The user may also select a plurality of different sets of items, including from different matrices and/or models, and join them together into a single presentation by “snapping” them together. The architecture of the system, which allows independent manipulation of items, categories, formulas and matrices without adverse effect, enables this selectable presentation function. In particular, the commonality of the dimensions and understandable common language category identifiers enables this functionality and makes it easy for the user to perform such dissecting and snapping together of different item sets.

The dependency inspector function is arranged to enable the user to observe on the display the dependency of a particular cell of the matrix on one or more other cells of the matrix, as well as the dependency of subsequent cells on that cell. This dependency may be examined with respect to broad and specific relationships. The dependency inspector enhances the transparency of the created model because the user may see in understandable language the features of a cell and the features of cells upon which that cell depends and which depend upon that cell. This functionality allows the modeler to detect more easily where an error may have occurred in the model, either by item information input, formula, or formula usage. In addition to providing the modeler with this improved error detection functionality, the dependency inspector allows third-party auditing of the model without requiring the auditor to be as knowledgeable about the model as the original creator. For example, an independent auditor tasked to confirm the financial records of an entity may be able to navigate the model generated by the system of the present invention using the dependency inspector. The understandable language of the system architecture and the presentation of slices of cell dependencies makes the model as a whole more transparent to anyone interested in evaluating it, including the advantage of easily understanding logical relationships embodied in the model.

The method of the present invention is carried out using a computing device controlled by a computer program to perform the steps associated with the method of the invention. The system includes a graphical user interface system configured to enable one or more users to observe one or more summary representations of one or more sets of information stored in the computing system, wherein the one or more summary representations are observable on the display of a computing device. The graphical user interface system includes a computer program configured to display on the display of the computing device one or more screen representations of information selection options and, for at least one of the information selection options, adjacent to the at least one information selection options, a representation of an information selection previously made.

These and other advantages and features of the system and method of the present invention will become apparent to those skilled in the art upon review of the following detailed description, the accompanying drawings and the appended claims.

### BRIEF DESCRIPTION OF THE DRAWINGS

The file of this patent application contains at least one drawing executed in color. Copies of this patent application with color drawing(s) will be provided by the Patent and Trademark Office upon request and payment of the necessary fees.

FIG. 1 is a simplified representation of a computer system suitable for performing the functions and steps embodied in the modeling system and method of the present invention.

FIG. 2 is a simplified block representation of the system of the present invention and its primary functional components.

FIG. 3 is a display of a matrix created using the system of the present invention showing an example of a first screen displayed after performing a first modeling step.

FIG. 4 is a display of a matrix created using the system of the present invention showing an example of a second screen displayed after performing a second modeling step.

FIG. 5 is a display of a matrix created using the system of the present invention showing an example of a third screen displayed while performing a third modeling step.

FIG. 6 is a display of a matrix created using the system of the present invention showing an example of a fourth screen displayed after performing the third modeling step.

FIG. 7 is a display of a matrix created using the system of the present invention showing an example of a fifth screen displayed after performing a fourth modeling step.

FIG. 8 is a display of a matrix created using the system of the present invention showing an example of a sixth screen displayed after performing a fifth modeling step.

FIG. 9 is a display of a matrix created using the system of the present invention showing an example of a seventh screen displayed while performing a sixth modeling step.

FIG. 10 is a display of a matrix created using the system of the present invention showing an example of an eighth screen displayed after performing the sixth modeling step.

FIG. 11 is a display of a matrix created using the system of the present invention showing an example of a ninth screen displayed after performing a seventh modeling step.

FIG. 12 is a display of a matrix created using the system of the present invention showing an example of a tenth screen displayed after performing an eighth modeling step.

FIG. 13 is a display of a matrix created using the system of the present invention showing an example of an eleventh screen displayed after performing a ninth modeling step.

FIG. 14 is a display of a matrix created using the system of the present invention showing an example of a twelfth screen displayed after performing a tenth modeling step.

FIG. 15 is a display of a matrix created using the system of the present invention showing an example of a thirteenth screen displayed while performing an eleventh modeling step.

FIG. 16 is a display of a matrix created using the system of the present invention showing an example of a fourteenth screen displayed after performing the eleventh modeling step.

FIG. 17 is a display of a matrix created using the system of the present invention showing an example of a fifteenth screen displayed after performing a twelfth modeling step.

FIG. 18 is a display of a matrix created using the system of the present invention showing an example of a sixteenth screen displayed after performing a thirteenth modeling step.

FIG. 19 is a display of a matrix created using the system of the present invention showing an example of a seventeenth screen displayed after performing a fourteenth modeling step.

FIG. 20 is a display of a matrix created using the system of the present invention showing an example of an eighteenth screen displayed after performing a fifteenth modeling step.

FIG. 21 is a display of a matrix created using the system of the present invention showing an example of a nineteenth screen displayed after performing a sixteenth modeling step.

FIG. 22 is a display of a matrix created using the system of the present invention showing an example of a first screen displayed after performing a first step of the data link function.

FIG. 23 is a display of a matrix created using the system of the present invention showing an example of a second screen displayed after performing a second step of the data link function.

FIG. 24 is a display of a matrix created using the system of the present invention showing an example of a third screen displayed after performing a third step of the data link function.

FIG. 25 is a display of a matrix created using the system of the present invention showing an example of a fourth screen displayed after performing a fourth step of the data link function.

FIG. 26 is a display of a matrix created using the system of the present invention showing an example of a fifth screen displayed after performing a fifth step of the data link function.

FIG. 27 is a display of a matrix created using the system of the present invention showing an example of a sixth screen displayed after performing a sixth step of the data link function.

FIG. 28 is a display of a matrix created using the system of the present invention showing an example of a seventh screen displayed after performing a seventh step of the data link function.

FIG. 29 is a display of a matrix created using the system of the present invention showing an example of an eighth screen displayed after performing an eighth step of the data link function.

FIG. 30 is a display of a matrix created using the system of the present invention showing an example of a ninth screen displayed after performing a ninth step of the data link function.

FIG. 31 is a display of a matrix created using the system of the present invention showing an example of a tenth screen displayed after performing a tenth step of the data link function.

FIG. 32 is a display of a matrix created using the system of the present invention showing an example of a screen display showing the outcome from activating the dependency inspector function.

FIG. 33 is a display of a matrix created using the system of the present invention showing an example of a screen display with the outcome from generating a formula including the use of the USING AS instruction.

### DETAILED DESCRIPTION OF THE PREFERRED EMBODIMENTS

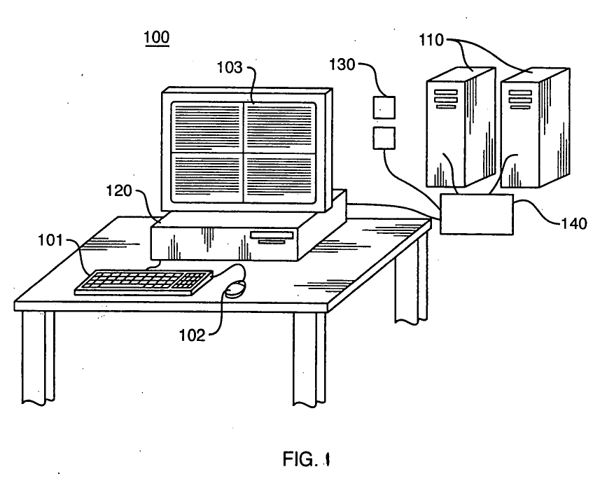

The present invention is a system and corresponding method for modeling outcomes based on gathered and calculated information. The system of the present invention is a set of functions embodied in a computing system programmed to perform functional steps associated with the method for modeling to be described herein. FIG. 1 shows a representation of a computer system 100 suitable for implementing the functions of the system. The computer system 100 shown is only one example of a suitable computing environment and is not intended to suggest any limitation as to the scope of use or functionality of the invention. For example, the computer system 100 may be associated with local or remote computing means, such as one or more central computers, such as server 110 in a local area network, a metropolitan area network, a wide area network, or through intranet and internet connections.

The computer system 100 may include one or more discrete computer processor devices, represented by desktop computer 120, for example. Examples of well known computing devices that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. The computer system 100 may include computer devices operated by one or more users, such as through a desktop, laptop, or servers, and/or one or more providers of services corresponding to one or more functions of the invention.

The server 110, the computer processor 120, or a combination of both may be programmed to include one or more of the functions of the invention system. One or more databases represented by database 130 that may be associated with the server 110, the computer processor 120, other computing devices, or any combination thereof, include information related to the use of the invention system. For example, the database 130 may include information of importance to the user. The database 130 may be populated and updated with information provided by an application provider capable of carrying out one or more of the steps associated with the system 10, one or more businesses, or any other information providers. All of the devices may be interconnected through one or more signal exchange devices, such as router/switch 140.

The invention may be described in the general context of computer-executable instructions, such as program modules, being executed by a computer. Generally, program modules include routines, programs, objects, components, data structures, etc. that perform particular tasks or implement particular abstract data types. As indicated above, the system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices.

The computer processor 120 and interactive drives, memory storage devices, databases and peripherals may be interconnected through one or more computer system buses. The system buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 100 typically includes a variety of computer readable media. Computer readable media can be any available media that can be accessed by computer system 100 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer system 100.

The computer system 100 further includes computer storage media in the form of volatile and/or non-volatile memory such as Read Only Memory (ROM) and Random Access memory (RAM). RAM typically contains data and/or program modules that are accessible to and/or operated on by computer processor 120. That is, RAM may include application programs, such as the functional modules of the system of the present invention, and information in the form of data. The computer system 100 may also include other removable/non-removable, volatile/non-volatile computer storage and access media. For example, the computer system 100 may include a hard disk drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system 100 to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processor 120. A user may enter commands and information into the computer processor 120 through input devices such as a keyboard 101 and a pointing device 102, commonly referred to as a mouse, trackball or touch pad. Other input devices (not shown) may include a microphone, joystick, game pad, satellite dish, scanner, or the like. These and other input devices are connected to the computer processor 120 through the system bus, or other bus structures, such as a parallel port, game port or a universal serial bus (USB), but is not limited thereto. A monitor 103 or other type of display device is also connected to the computer processor 120 through the system bus or other bus arrangement. In addition to the monitor 103, the computer processor 120 may be connected to other peripheral output devices, such as printers (not shown).

The computer processor 120 may be configured and arranged to perform functions and steps embodied in computer instructions stored and accessed in any one or more of the manners described. The functions and steps, such as the functions and steps of the present invention to be described herein, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processor 120, instruct the computer processor 120 to perform one or more processes or acts described herein, and/or various examples, variations and combinations thereof. Such instructions may be written in any of a plurality of programming languages, for example, XML, Java, Visual Basic, C, or C++, Fortran, Pascal, Eiffel, Basic, COBOL, and the like, or any of a variety of combinations thereof. The computer-readable medium on which such instructions are stored may reside on one or more of the components described above and may be distributed across one or more such components.

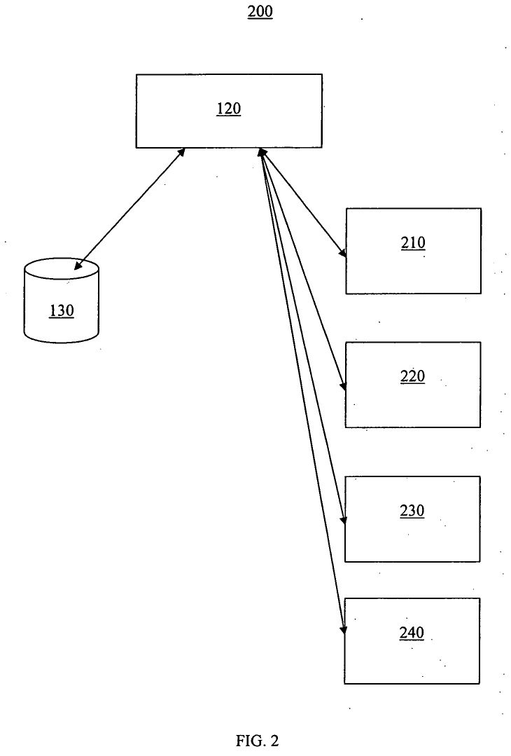

With reference to FIG. 2, a modeling system 200 of the present invention includes a plurality of functions embodied in one or more computer programs executable through the computer processor 120 of the computer system 100. Primary functions of the modeling system 200 include a model building function 210, a data link function 220, a dependency inspector function 230, and a presentation function 240. The system 200 includes other functions referred to herein, and each of the identified primary functions to be described may include one or more subfunctions. The modeling system 200 represented in FIG. 2 may be embodied in one or more computer programs and one or more computer systems. It may be embodied in software, hardware, firmware or any combination thereof. The functions shown may be performed through the computer processor 120 as a single computing mechanism, or through a plurality of computer processors represented by processor 120. The modeling system 200 may include one or more databases represented by database 130, which database may be embodied in the computer processor 120 or in one or more other computer systems in electronic communication with the computer processor 120. It is to be noted that a model generated using the system 200 of the present invention, or any components thereof, may be used without specific presentation of the display of the computer system 100. For example, the output of model information may be transferred among computer devices, or within a networked computing system, without specific presentation on a display. Further, the model building function 210 may be used to perform calculations without requiring presentation on such a display.

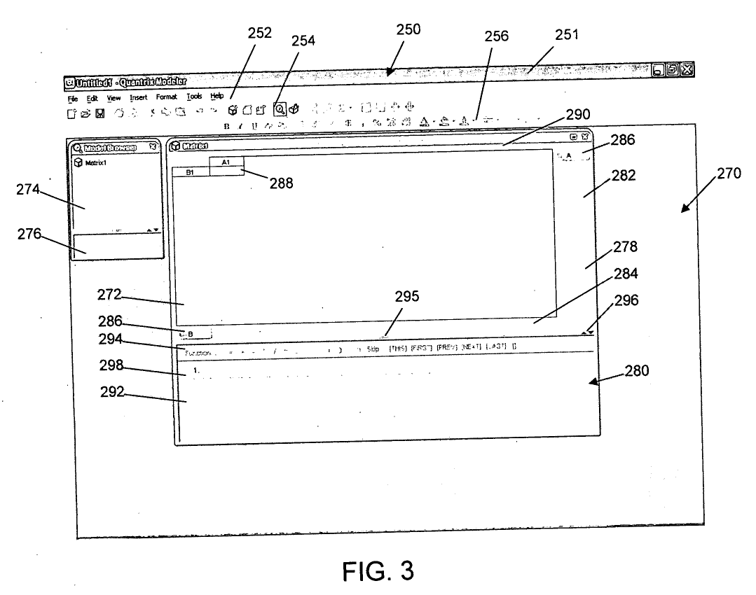

With reference to FIGS. 3-16, the model building function 210 and the presentation function 240 of the system 200 enable a user to view and build a model of one or more outcomes produced through a combination of information and calculations. FIGS. 3-16 are graphical representations of the screens viewed by the user in the building of a model. The model building function 210 embodied in a modeling computer program including a calculation engine to be described herein and embodied in the model building function 210, is activated or launched by clicking on an icon representing the program, or otherwise initiating application opening through desktop activation methods well known to users of computer programs. Upon activating the system 200, the computer processor 120 enables the user to observe on display 103 a first screen as shown in FIG. 3. The first screen, as with all other screens created through use of the system 200, is a graphical user interface, which enables the user to see one or more matrices and to manipulate the content of each matrix through user inputs, generally either with keystrokes of the keyboard 101, and/or clicking or clicking and dragging with the mouse 102 icons, categories, items, elements, formulas, and the like represented on the display 103.

As shown in FIG. 3, the model building function 210 first displays a graphical user interface. The interface includes a tool area 250 and a work area 270. The tool area 250 includes a model title bar 251, a menu bar 252, a standard toolbar 254 and a format toolbar 256. It is to be noted that fewer of the indicated bars may be shown, and alternative types of such bars may be arranged on the display 103 to present to the user tools that may be employed in the process of creating a model. The title bar 251 presents the title of the file including a model. In addition, by clicking and dragging on its perimeter, the user may adjust the position and size of the entire model window. The menu bar 252 includes command options for creating a model. The standard toolbar 254 and the format toolbar 256 include shortcut icons the user may activate for performing selectable functions. Any one or more components of the tool area 250 may be customized.

The work area 270 is a section of the model window within which one or more matrices may be created and modified. The work area 270 includes the option to show more than one window. Two windows are shown in FIG. 3. The first is a modeling matrix 272 and the second is a model browser 274. The model browser 274 functions as a “roadmap” to one or more matrices and/or associated presentations of a model. The user may click on a particular component shown in the model browser 274 to call up that component for observation, manipulation or other actions of choice. The model browser 274 provides a convenient mechanism to show the array of matrices for a given model and to access quickly a particular matrix or presentation. The model browser 274 may be used to include one or more folders of files as part of the window display. The model browser 274 also includes a comments section 276 to add notes and comments regarding a particular modeling component listed.

The modeling matrix 272 includes a matrix work area 278 and a formula editor 280. A column tray 282 and a row tray 284 are located on one side and below the matrix work area 278, respectively. One or more category tiles 286 are positioned in either of the column tray 282 and the row tray 284. The selectable locations of these category tiles 286 within these trays establishes whether an item 288 of the matrix work area 278 is positioned in a column or a row of a matrix. As shown in FIG. 3, items in columnar form will be those located below item column A1, and items in row form will be those located to the right of item row B1. Items and groups of items may be added manually or through a data import process to be described herein with respect to the data link function 230. The user may define and change item groupings as being in column or row form. That is achieved by clicking on a selected category tile 286 and dragging it to the column tray 282 or the row tray 284.

A two-dimensional model only has one category tile in the column tray and one category tile in the row tray. A multi-dimensional model includes a plurality of category tiles in either or both of the column tray 282 and the row tray 284, as shown in example screen shots following FIG. 3. Additionally, a filter tray 290 located above the matrix work area 278 enables a simplified view of a model matrix by enabling the user to select certain portions of the matrix or selectable groups of items for display on the display. As a result, complex multi-dimensional matrices may be boiled down to a simplified display. However, the architecture of the system 200 of the present invention enables such a selectable display without affecting the set of items and categories behind the display.

The formula editor 280 includes a formula field 292 and a formula toolbar 294. All formulas used for making calculations based on information of one or more items of the matrix work area 278 are viewed in the formula field 292. One or more formulas are entered, editable, and auditable in the formula field 292 of the formula editor 280. The user may selectively make visible on the display as many formulas as desired. The size of the formula field 292 observable on the display may be adjusted by the user by clicking and dragging on the perimeter of the work area 270, clicking and dragging on the resize handle 295, and/or clicking on one of the two arrow buttons 296 located above the formula toolbar 294. The formula editor 280 further provides status notice to the user regarding the condition of a created formula. Specifically, in location 298 a status indicator shows whether a formula is properly configured or if there is an error condition. Formulas may be customized and generated by the user. In addition, standardized formula functions may be activated in any individual one of the formula fields 292. The standardized formula functions may be activated by clicking on them in the formula toolbar 294.

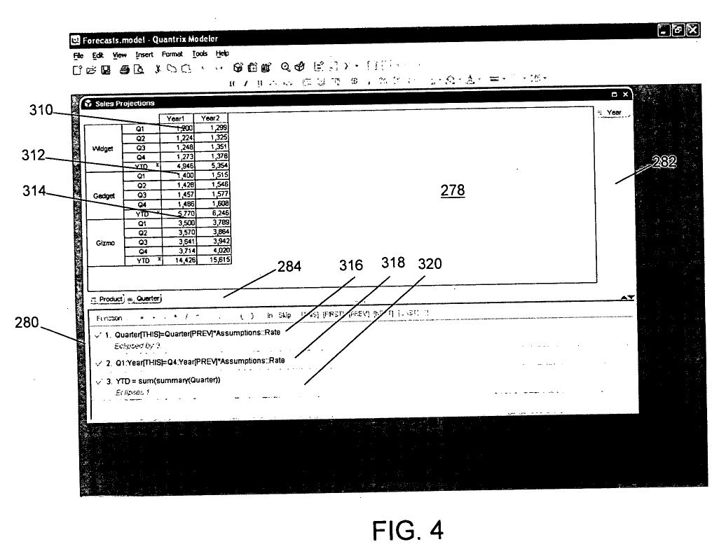

An explanation of the model building function 210 is presented herein with respect to an example model beginning at FIG. 4 in the matrix work area 278. In that figure it can be seen that an initial multi-dimensional model is under development. The model includes a matrix named Sale Projections and is directed to sales by a fictitious company of three products named Widget, Gadget and Gizmo. The model is multi-dimensional in that sales of the products are shown by quarter and by year. A traditional two-dimensional spreadsheet would only be able to display sale by product per quarter or by year, but not both. That would require a separate worksheet. The Sales Projections matrix of FIG. 4 is arranged with the Year category in the column tray 282 and the Product and Quarter categories in the row tray 284.

The matrix was initially populated with three items of sales information, which information may be input into a cell manually or automatically by importing from a source forming part of the matrix under development or from another external source. The three items that were input are shown in the cells designated as cells 310, 312, and 314, as year one first quarter sales of Widgets, Gadgets, and Gizmos, respectively. The remaining cells of the matrix of FIG. 4 have been calculated using formulas 316, 318, and 320 of the formula editor 280. Formula 316 calculates projected quarterly sales in remaining quarters two, three and four of a given year for each product based on one or more assigned assumptions to be described herein. Formula 318 calculates projected quarterly sales in all quarters on the following years based on the assigned assumptions. Formula 320 calculates projected annual sales per year based on the input items in cells 310, 312, and 314, and the calculated items in the remaining projected quarterly sales.

It can readily be seen in the simplified matrix of FIG. 4 that the model building function 210 enables a model building user to display understandable natural language labels for categories of items, thereby making the model itself easier to understand. In addition, the model building function 210 enables the model building user to display formulas below the matrix in the formula editor 280, thereby making the relationship between calculated item information and input items transparent. Moreover, the model building function 210 is configured such that a single formula may be applied to multiple cell items. In a conventional two-dimensional spreadsheet, each formula is unique in that each calculation cell must have its own formula associated with the unique cell coordinates.

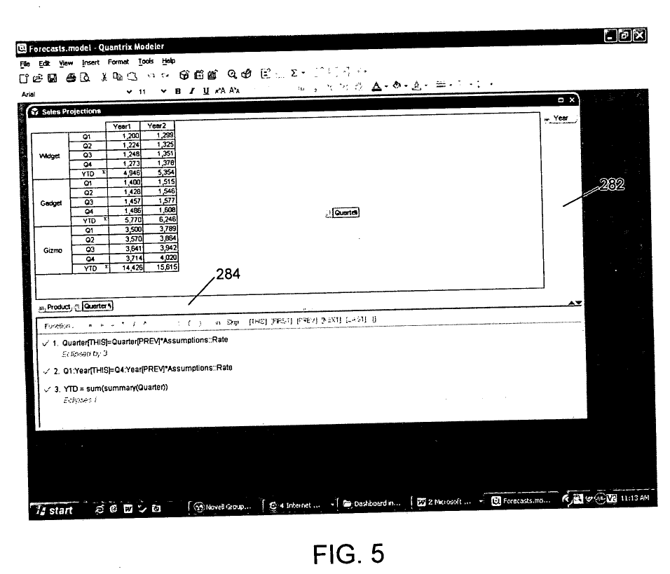

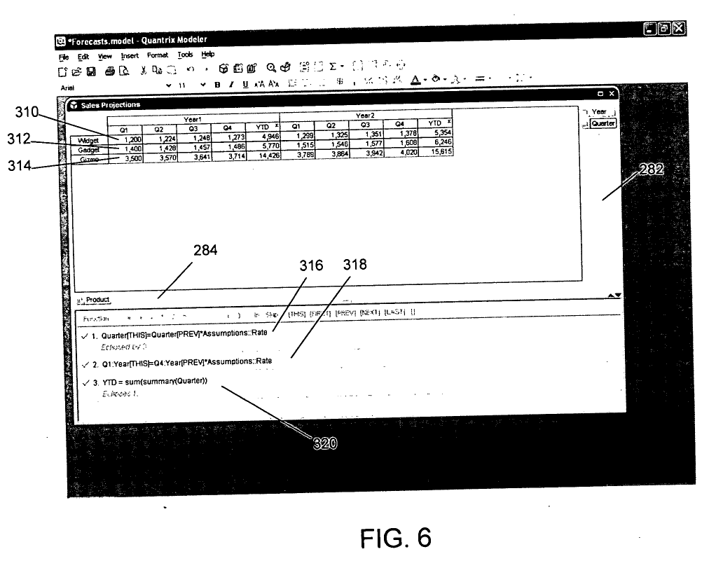

With continuing reference to the simplified example model under development initiated above and with regard to FIGS. 5 and 6, the model building function 210 enables the user to create a new presentation of the input and calculated items without any change to the formulas or making manual changes to any cells of the matrix. Specifically, in order to change the presentation of the matrix so that the Year and Quarter are located in the column tray 282, the user must simply click on the Quarter category tile in the row tray 284 and drag it to the column tray 282. FIG. 5 displays the matrix in the process of moving the Quarter category tile from the row tray 284 to the column tray 282. FIG. 6 displays the new orientation of the matrix under development with the new organization of the input and calculated items, now with the quarter items shown in columnar arrangement. It can be seen that the information represented by the items has not changed with the change in presentation. Similarly, the formulas have not changed. This powerful capability of the modeling system 20 of the present invention is the result of its architecture, which “unlinks” the logic, structure, and presentation aspects.

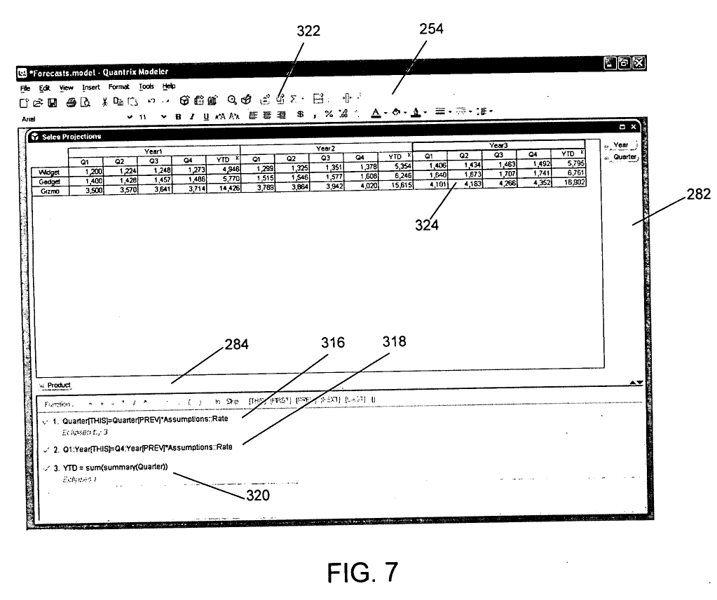

FIG. 7 illustrates the outcome of performing a step of adding a new item group corresponding to an existing item category. Specifically, a new year designated as Year 3 has been added to the matrix. This is easily achieved with the model building function 210 by clicking on an existing item category, in this case item category Year 2 has been highlighted, and then using Insert button 322 of the standard toolbar 254, or simply clicking on the “Enter” button of the keyboard 101. Doing so automatically produces a new item grouping 324, with formulas 316, 318, and 320 populating the cells of the new item group without any further input from the user. This step may be repeated as often as desired and may be performed with other item group selections.

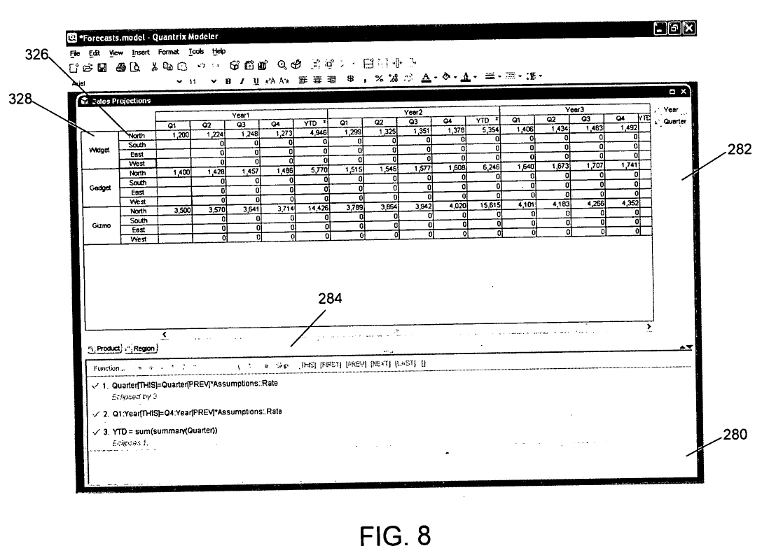

FIG. 8 illustrates the outcome of performing the step of adding another category to the matrix, thereby changing it from a three-dimensional matrix of the prior figures of the example model building to a four-dimensional matrix. This may be accomplished by clicking on a category tile in the tray where the new category is to be located. As shown in FIG. 8, the new category tile has been added to the row tray 284. It could have been added to the column tray 282 if that was of interest. The result is a new row set shown at location 326. When the new category tile is added, a single cell row is generated and positioned in the matrix in relation to the positioning of the new category tile to the existing category tile in the row tray 326. That is, as shown in FIG. 8, the Product category tile is to the left of the new category tile designated as the Region category. Correspondingly, the row set designated as 326 is to the left of the Product row set 328. The region category may be expanded by clicking on the initial cell in row set 326 and clicking Enter as many times as desired for the number of new rows desired for that category. In FIG. 8 there are four new row sets named North, South, East and West.

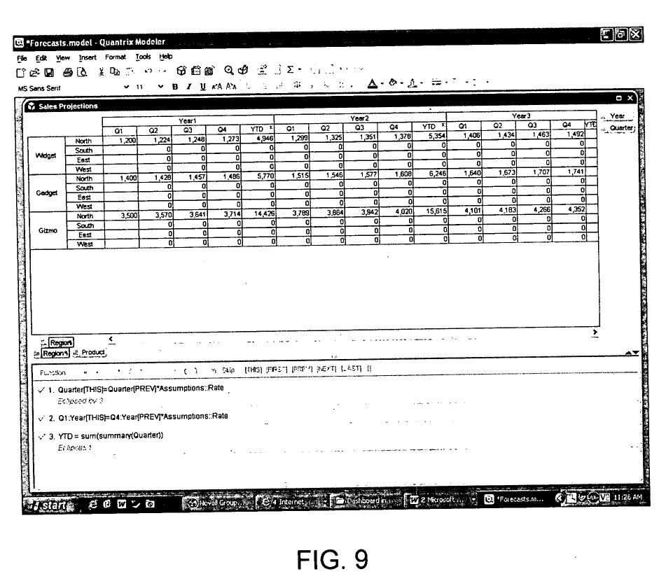

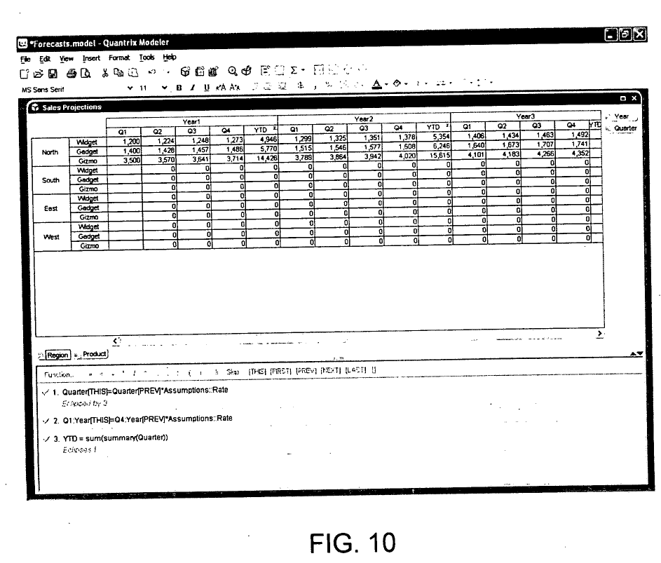

The addition of a new category does not automatically generate new items. Instead, that must be accomplished by manual addition of new items, automated importing of new items, calculation of new items based on one or more new formulas added to the formula editor 280, or any combination thereof. The default location for the items existing at the time of addition of the new category is the first set of cells for the existing categories. FIG. 9 shows the step in progress of changing the orientation of the new matrix arrangement with the Region category located to the left of the Product category in the row tray 284. FIG. 10 shows the new matrix presentation with the move of the Region category completed. Again, it can be seen that existing items and formulas do not change with the reconfiguration of the matrix presentation.

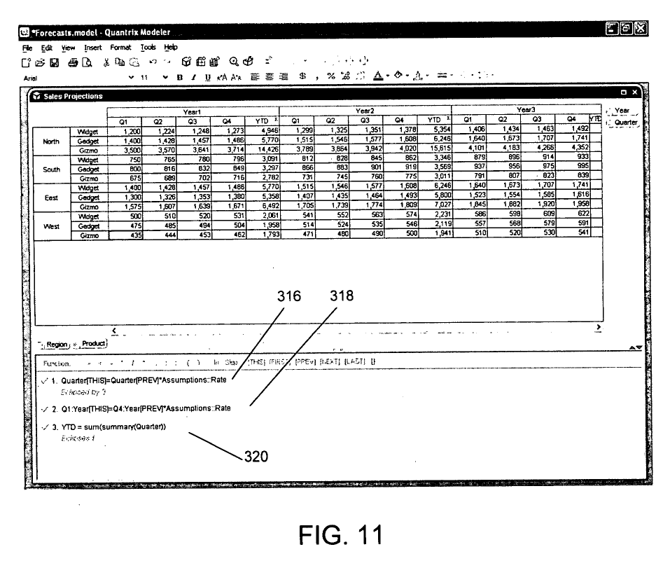

FIG. 11 illustrates the outcome of performing the step of adding input and calculated items to fill the matrix under development with the new Region category. In the example represented in this figure, input items have been added to the Year 1 Q1 column for each Product in each Region. Formulas 316, 318, and 320 automatically populate the remainder of the cells of the matrix with calculated items.

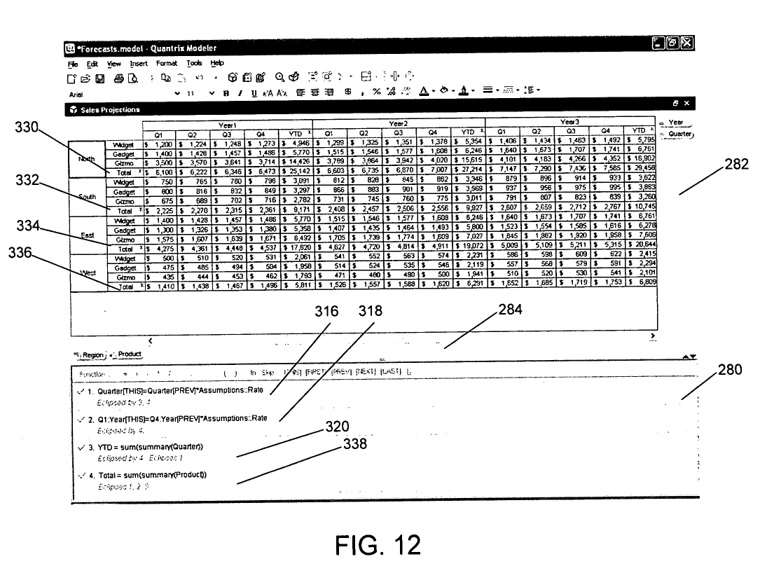

FIG. 12 illustrates the outcome of performing the step of adding a new formula to the formula editor 280. Specifically for this example, the total sales per Product have been totaled by Region. This is achieved with the model building function 210 by clicking on an existing item category, in this case item category Product of the row tray 284 was highlighted and Insert>Summary Item>Sum of the menu bar 252 was selected to generate new row sets 330, 332, 334, and 336, named as Total for each Region. Items existing at the time of the additional row sets remain the same, as do existing formulas 316, 318, and 320. However, the new inserted calculation is represented as new formula 338 in the formula editor 280. It is to be noted that formulas 316 and 318 are standard formulas created by the user and formulas 320 and 338 are summary formulas automatically created by the model building function 210.

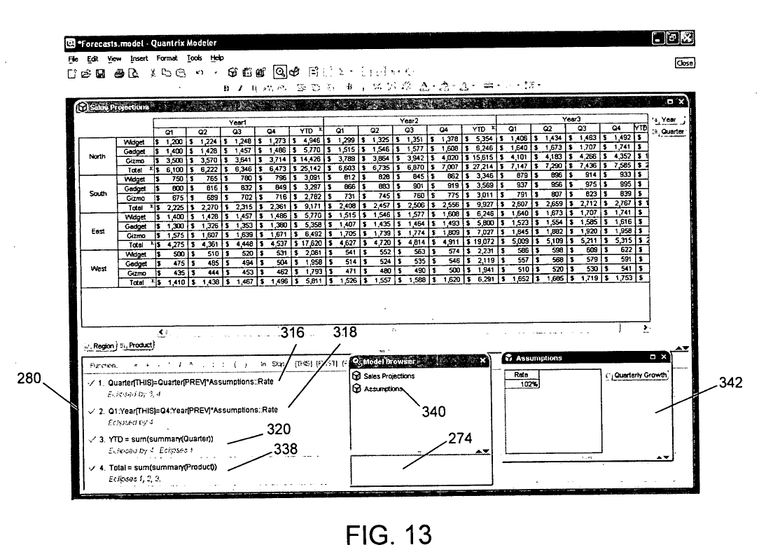

FIG. 13 shows the outcome of highlighting formula 338, which includes highlighting the row sets corresponding to the output of the calculation performed through that formula. The figure further shows the model browser 274 presented in the work area 270 overlaying the model matrix 272. The presentation function 240 of the system 200 enables the user to selectably view one or more windows representing individual matrices as well as the model browser 274. In the example model under development represented in FIGS. 4-16, there are two matrices under development, the Sales Projections matrix and the related Assumptions matrix.

As further shown in FIG. 13, by highlighting Assumptions icon 340 of the model browser 274, the Assumptions matrix can be viewed while also viewing the Sales Projections matrix. The Assumptions matrix of FIG. 13 is a simple single item matrix showing that the assumptions rate used in the calculations performed through formulas 316 and 318 represents a 102% quarterly growth rate in sales. That is, a single category of items, represented by columnar category tile Quarterly Growth in column tray 342, comprises this matrix. The Assumptions matrix may be modified in the manner described with regard to the Sales Projections matrix. That is, additional categories and item groups may be added and formulas included, and the presentation of the matrix may be reconfigured without changing input or calculated items or the formulas. At the same time, the relationship between the two remains in effect through the tying formulas viewable in the formula editor 280 of the Sales Projections matrix. The Assumptions matrix is also easily understandable as a result of the use of simple language labels.

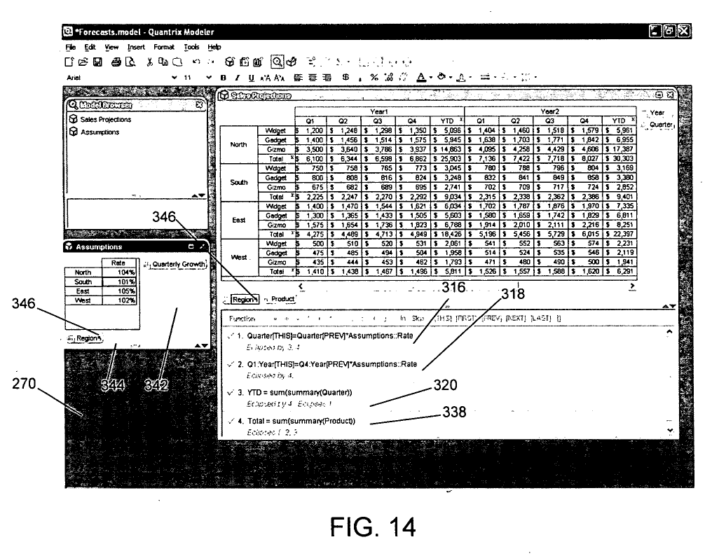

FIG. 14 shows the Sales Projections matrix, the Assumptions matrix and the model browser 274 of FIG. 14 with each corresponding window sized and re-positioned so that none overlaps the other within the work window 270. FIG. 14 illustrates the outcome of performing the step through the model building function 210 of changing assumptions of the Assumption matrix and the effect of doing so on the items of the Sales Projections matrix. First, a new category tile has been added to the Assumptions matrix. That category tile is the Region category tile. It was added to the Assumptions matrix from the row tray 284 of the Sales Projections matrix by clicking on it and dragging it through the work area 270 to row tray 344 of the Assumptions matrix. That step effectively copies and links the Region category from the Sales Projections matrix to the Assumption matrix such that the related matrices use the same Region category items. The linking of categories is indicated by directional arrow 346 in both matrices.

With continuing reference to FIG. 14, the Assumptions matrix has been modified to enable the user to select different quarterly growth rate values by sales region. Specifically, by adding the Region category, four Rate item cells are automatically created, corresponding to the four regions of the Sales Projections matrix. Each cell for which items are to be inserted may be highlighted for that purpose. As shown, each region has a different rate based on input information. Through formulas 316 and 318, the quarterly sales information of the Sales Projections matrix has been automatically updated to reflect the new assumptions of quarterly growth. Further, through formulas 320 and 338, annual sales and annual product sales calculations have been automatically repeated to reflect the update of the assumptions rates by region. This can be observed by viewing the individual calculated items of the FIG. 14 presentation of the Sales Projections matrix of FIG. 14 with the same calculated items of the Sales Projections matrix of FIG. 13.

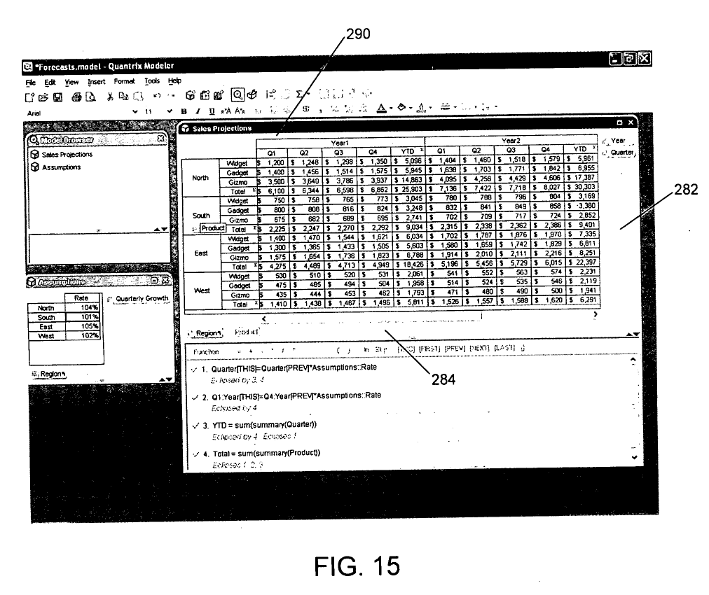

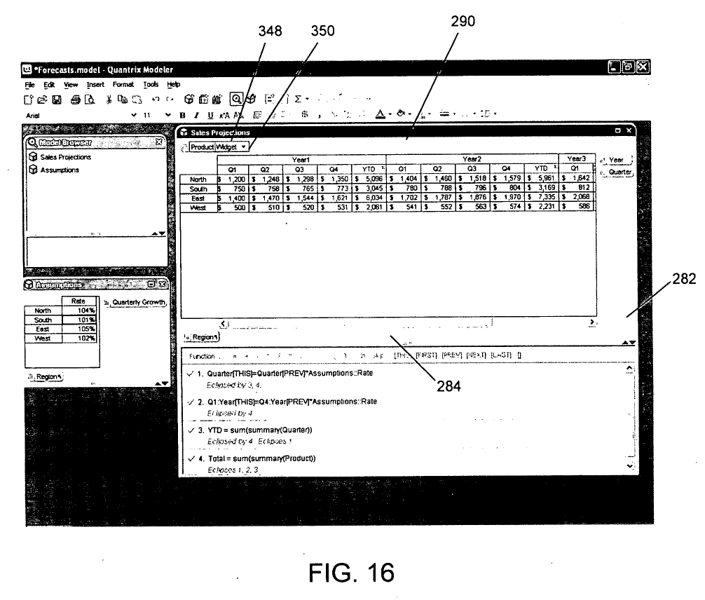

FIGS. 15 and 16 illustrate the outcome of performing the step of filtering information for changed presentation of the matrix under development. In the example shown, one dimension is removed from the matrix presentation so that the view is of a three-dimension model rather than a four-dimension model. This is achieved through the model building function 210 without changing or losing any input or calculated items or any formulas by employing the filter tray 290. Specifically, the user must simply click on a desired category tile, the Product category tile of the row tray 284 in this example, and drag it to the filter tray 290. FIG. 15 displays the matrix in the process of moving the Product category tile from the row tray 284 to the filter tray 290.

FIG. 16 displays the new orientation of the matrix under development with the new organization of the input and calculated items, now without the individual product items shown. Instead, a modified category tile 348 is shown positioned in the filter tray 290. It includes a filter drop down menu tab 350, wherein the user may select which of the individual products is to be displayed in the Sales Projections matrix. That filtering function enables the user to reduce the amount of information viewable on the display without losing all of the information input or calculated. It can be seen from the presentation of FIG. 16 that the quarterly and annual sales information is only for the selected Widget product. The user may click on the drop down menu tab 350 to select another product to view its sales information alone. This capability to render different and simpler views of a single set of information and formulas without loss of that information or the formulas, no matter how extensive or complex, is a result of the unlinking of the logic, structure and presentation aspects of the system 200.

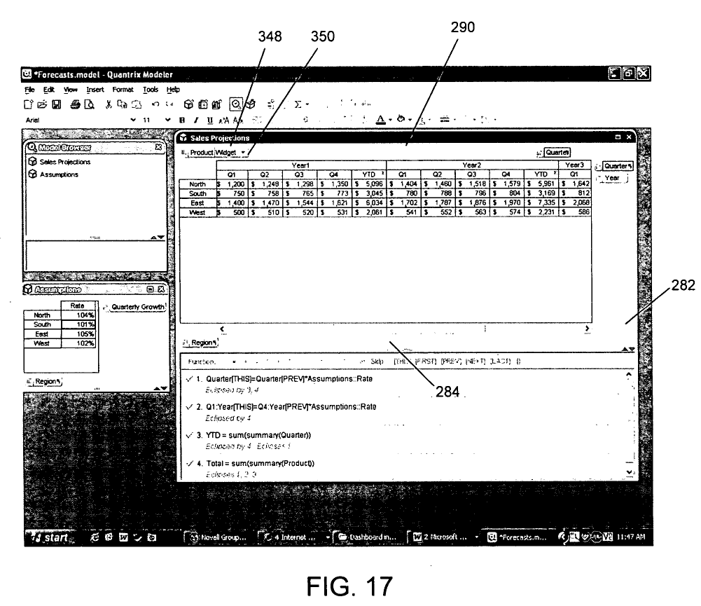

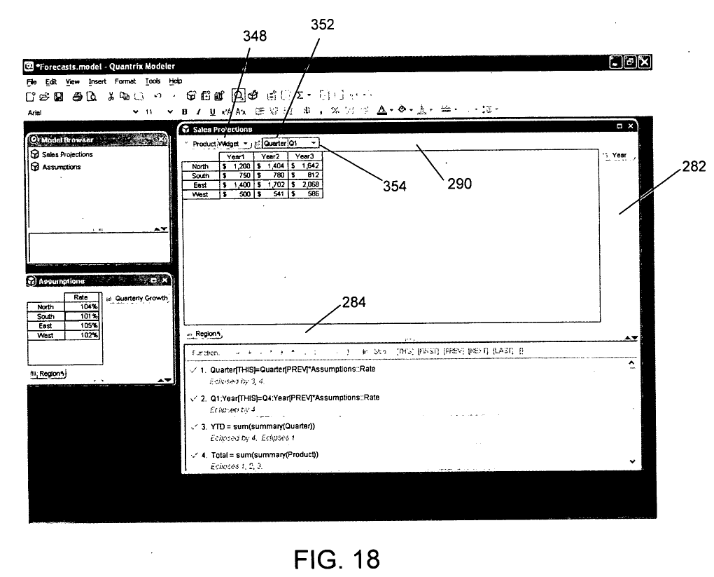

As a further illustration of the filtering function of the model building function 210, FIGS. 17 and 18 show an example of additional simplification of the presentation of Sales Projections matrix information. In this example, the sales information is filtered to show by product and quarter the regional and annual sales information only. That is, the presentation has been reduced from the three-dimension matrix presentation of FIG. 16 to a two-dimension matrix presentation in FIG. 18. Specifically, the user must simply click on the desired column category tile, the Quarter category tile of the column tray 282 and drag it to the filter tray 290. FIG. 17 displays the matrix in the process of moving the Quarter category tile from the column tray 282 to the filter tray 290.

FIG. 18 displays the new orientation of the matrix under development with the new organization of the input and calculated items, now without the individual product items and individual quarter information shown. The movement of the Quarter category tile to the filter tray 290 generates a second modified category tile 352 including a second drop down menu tab 354, wherein the user may select which of the individual quarters sales information sets, for a selectable individual product, is to be displayed in the Sales Projections matrix. That filtering function enables the user to reduce the amount of information viewable on the display without losing all of the information input or calculated. It can be seen from the presentation of FIG. 18 that the sales information is only for quarter Q1 and only for the Widget product. The user may click on the second drop down menu tab 354 to select other quarterly information for a selected product to view alone.

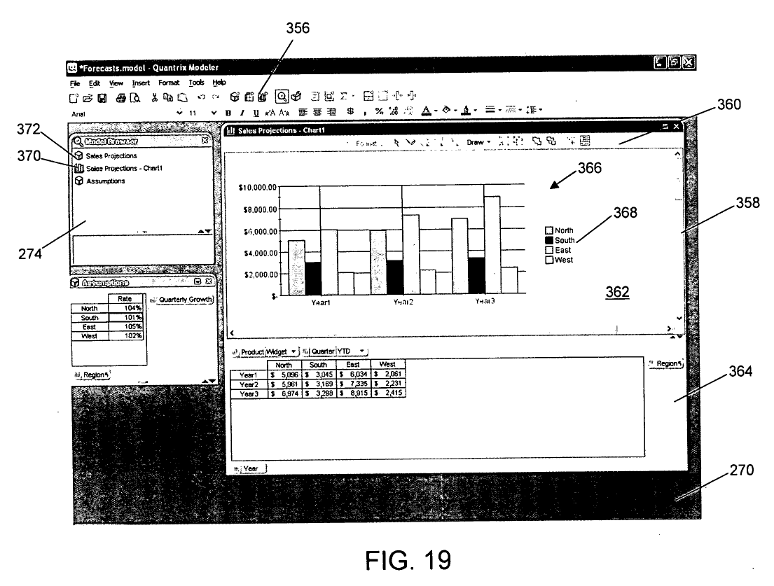

The model building function 210 in combination with the presentation function 240 enable a user to display on the display 103 the input and calculated items by category in different forms, including in chart form. FIG. 19 illustrates the outcome of performing the step of creating a chart based on information of the Sales Projections matrix. Specifically, the user viewing that matrix on the display clicks on chart insert icon 356 of the standard toolbar 254. That action generates a chart window 358 in the work area 270. The chart window 358 includes a chart toolbar 360, a charting canvas 362 and a charting table 364. The chart toolbar 360 includes a plurality of icons and dropdown menus and the like, which the user may activate to perform an array of optional functions. The charting canvas 362 includes a chart 366 of item information to be displayed in chart form, and a chart legend 368 to pair color designations with one or more categories of items displayed on the chart 366.

With continuing reference to FIG. 19, the user may also view in the work area 270 the model browser 274 and, if of interest, the Assumptions matrix or such other matrices that the user may wish to observe simultaneously. Each of the noted windows and matrices may be overlaid over each other, hidden, brought to the front, or isolated as the interest of the user dictates. It can be seen that the insertion of the chart window 358 produces the addition of a chart icon 370 in the model browser 274, which when highlighted opens the chart window 358 for manipulation. The positioning of the chart icon 370 below the sale projection icon 372 indicates that this particular chart window 358 is linked to the Sales Projections matrix indicated by icon 372. For the example of the present invention described herein, that Sales Projection matrix is the same one as shown in FIGS. 4-18. Therefore, any changes made to the items, structure or logic of the Sales Projections matrix will effect corresponding changes in the chart 366. However, any changes to the presentation of the Sales Projection matrix, such as moving a category tile from one tray to another, will not effect any changes to the chart 366.

The charting table 364 and the chart 366 are linked together in that changes to one effect changes to the other. Moreover, the charting table 364 initially embodies the display of the same items shown in the Sales Projections matrix of FIG. 18 prior to clicking on the chart icon 356, except that: 1) the filter of second drop down menu tab 354 was clicked on to change the display to year-to-date sales information rather than Q1 quarter sales information; and 2) the Region category tile has been moved from the row tray 284 to the column tray 282 while the Year category tile has been moved from the column tray 282 to the row tray 284. The result in the chart display is that the Year category is displayed on the x-axis of the chart 366, while the item information is displayed on the y-axis by Region category. This produces a chart display of the Widget sales year-to-date by year and by region.

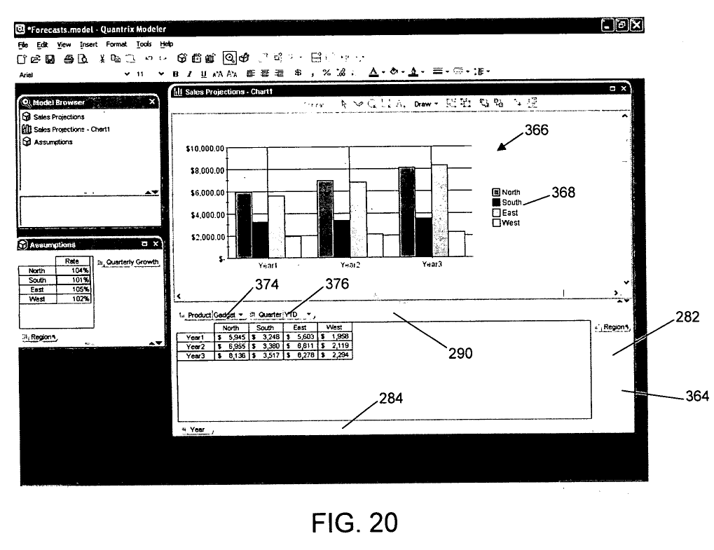

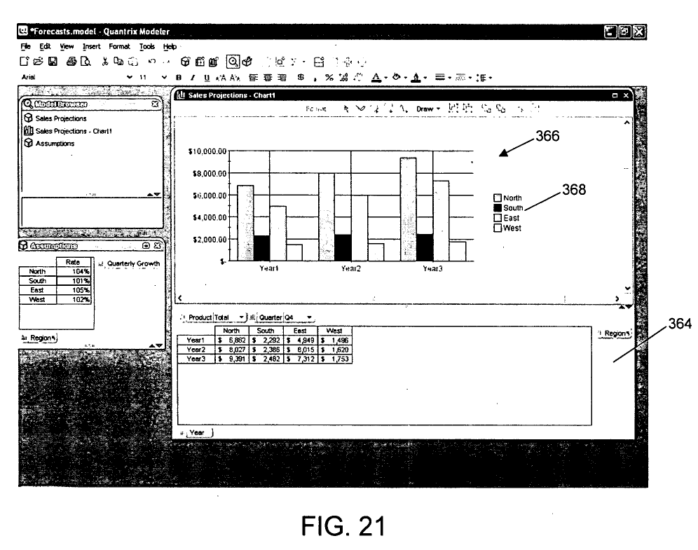

As illustrated in FIG. 20, the user may change the display of the chart 366 to reflect the sales information for a different product. In this figures, third dropdown menu tab 374 of the chart table 364 was clicked on and the Gadget product selected for sales information to be displayed. It can be seen that the chart 366 continues to show sales information by year and by region, but now the information associated with the updated version of the chart table 364 is for the Gadget product rather than the Widget product. The user may activate either or both of the third dropdown menu tab 374 or fourth dropdown menu tab 376 to change the display of information presented on the chart 366. Further, the x-axis, the y-axis and the legend 368 may be changed on the chart 366 by moving one or more positions of one or more of the category tiles to one or more of the column, row, and filter trays. The chart view may also be modified but without modifying the appearance of the table of the chart table 364 by clicking on and dragging an item of the legend 368 to a new position with respect to the other items of the legend 368 to highlight an aspect of the information. For example, in FIG. 21 it can be seen that the West region item has been moved to second on the list from last on the list in FIG. 20.

It is to be noted that a user of the model building function 210 of the system 200 of the present invention may select from a wide range of chart arrangements, limited only by the extent of information to be charted. This may all be accomplished using a single matrix including input items, calculated items, or a combination of the two. Moreover, it is to be noted that multiple charts may be created. The present invention is fully scalable such that large numbers of items may be modeled using a large number of formulas and they may all be characterized in table and chart format without requiring complete re-creation of item groupings and repetition or re-creation of formulas.

With reference to the screen captures of FIG. 3 and FIGS. 22-31, the system 200 of the present invention is configured through the model building function 210 and the data link function 220 to enable the user to integrate information (data) from one or more sources external to the system 200 into the model building functionality. In particular, the system 200 enables the integration of information that may be in a form different from the standardized form of the information used in building the model through model building function 210 as previously described. The model building function 210 enables the user to create a matrix using items in a multidimensional OLAP style. The data link function 220 allows the user to transfer external data in selectable portions or in entirety into the model building function 210. The data link function 220 further enables this mapping in of external data of varied format to the model building function 210 seamlessly and without alteration of the status of the remaining elements of a model under development. The system 200 allows the user to work on the model with originally generated data, imported data of differing format, or a combination of the two, all without having to re-configure relationships and/or formulas.

The data link function 220 includes a source configuration subfunction and a destination configuration subfunction. The source configuration subfunction prompts the user to select from a list the original form of the external information to be inserted into a matrix or spreadsheet to be created using the system 200. The forms of information to be configured for integration into the matrix include, but are not limited to: Delimited Text File, JDBC/ODBC Data Source, Two Dimensional Data Matrix, Web Services (SOAP), and XML Data Source. It is to be noted that other forms of information to be integrated may be added to this list without deviating from the general functionality of the source configuration subfunction. Upon confirming that the external information has been configured in a suitable format, the user initiates the destination configuration subfunction. The destination configuration subfunction enables the system user to generate a matrix suitable for manipulation by the model building function 210. Specifically, the user is prompted to select from a list the form of the matrix to be used in the modeling function. The forms of the matrix to be selected from include, but are not limited to: Multi Dimensional OLAP Analysis model and Two Dimensional Matrix model.

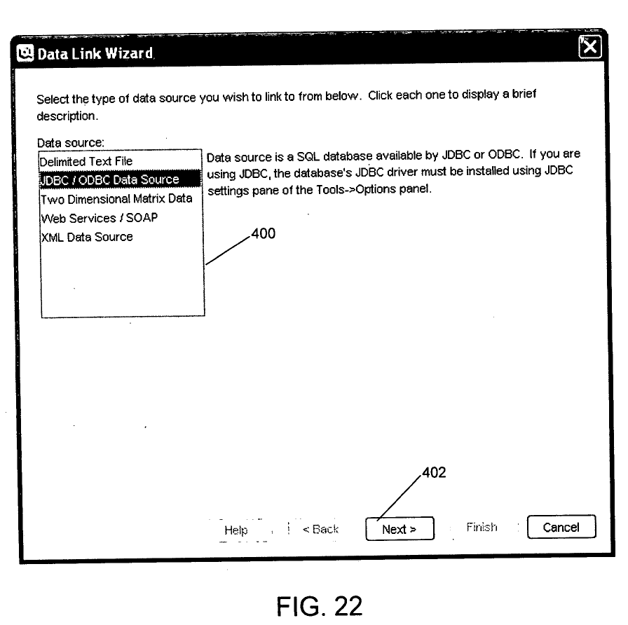

The data link function 220 is opened by clicking through the Tools>DataLink>Create DataLink tool activation menu of the menu bar 252 shown in FIG. 3. This action opens an interactive subfunction to generate a graphical user interface directing the user through a series of tasks to integrate the external data into multi-dimensional modeling form in conformance with the operation of the system 200. The interactive subfunction is referred to herein as the Data Link Wizard. Those skilled in the art will recognize that the Data Link Wizard acts generally in the manner of an application program installation referred to as an Installation Wizard. The outcome of performing the step of activating the Data Link Wizard is illustrated in FIG. 22.

An example process for integrating external data is represented in FIGS. 22-31, in which data from a Microsoft® Access® database related to Engine sales are directed into a matrix to be created with the model building function 210. The screen of FIG. 22 is the first Data Link Wizard interactive screen observed on the display 103 of the computer system 100. It includes data source options window 400, which lists several formats of data sources to be integrated. The user selects from the list the current format of data to be included in a model and then clicks on the Next button 402 to proceed to the next Data Link Wizard interactive screen.

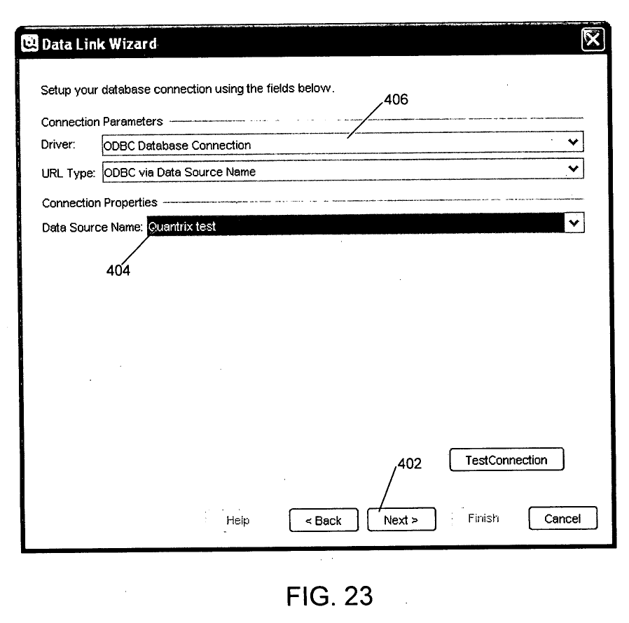

FIG. 23 illustrates the outcome of performing the step of clicking on the Next button 402 of FIG. 22 after having selected as the external data source format JDBC/ODBC Data Source. In the interactive screen of FIG. 23, the user is prompted to select or enter information identifying the source of the data of the format selected in the previous screen. The example of the process shown in this set of figures includes data from a source named Quantrix test in the data source name menu bar 404 to be opened using a driver designated in driver menu bar 406. Clicking on the Next button 402 begins the process of opening the named data source from the identified source location.

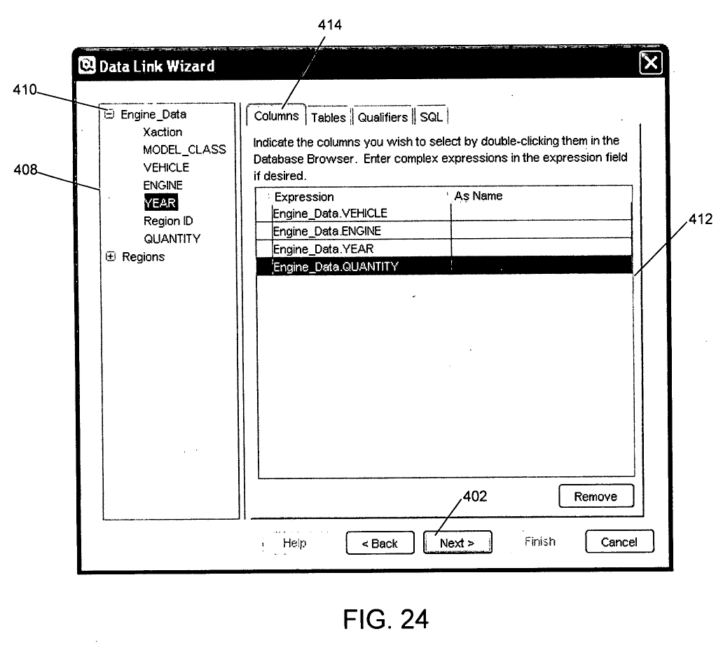

FIG. 24 illustrates the outcome of performing the step of clicking on the Next button 402 of FIG. 23 after having selected the data source by the name Quantrix test. In particular, the screen of FIG. 24 includes data sets window 408. The data set window 408 shows two primary types of data, Engine_Data and Regions. Clicking on tab 410 of the primary data set Engine_Data generates a sublisting of sets of information related to engine sales. Double clicking on one or more of the sublistings moves such selected sublistings to setup window 412 with column tab 414 activated. This interactive window initiates the format of the matrix to be created using the external data and the model building function 210. Specifically, inserting the listed sublistings of Engine information associated with Engine sales under the column tab 414 dictates what types of information are to incorporated into the matrix. Clicking on the Next button 402 begins the process of organizing the data into designated sets.

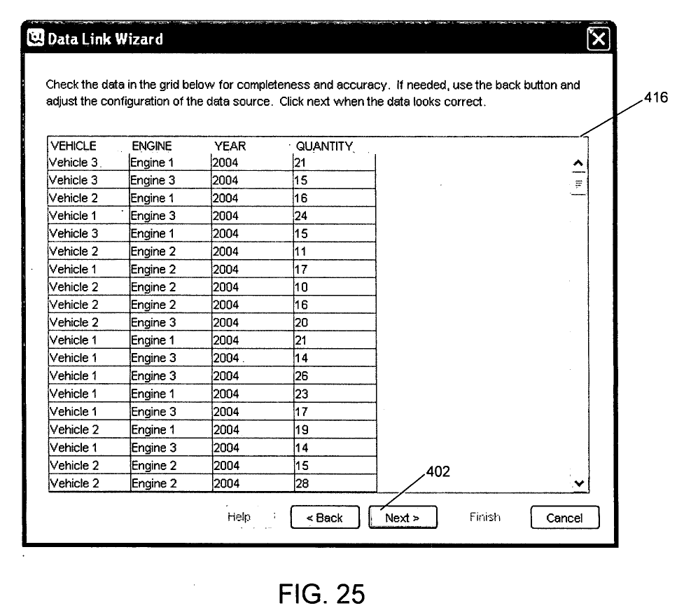

FIG. 25 illustrates the outcome of performing the step of clicking on the Next button 402 of FIG. 24 after having selected the data sets to be included in the matrix under development. In particular, the screen of FIG. 25 includes data grid 416 in columnar form, as directed by the function represented in FIG. 24. The data grid 416 may be reviewed by the user to confirm that it accurately reflects the information to be incorporated into the matrix under development. Clicking on the Next button 402 begins the subfunction of configuring the destination data.

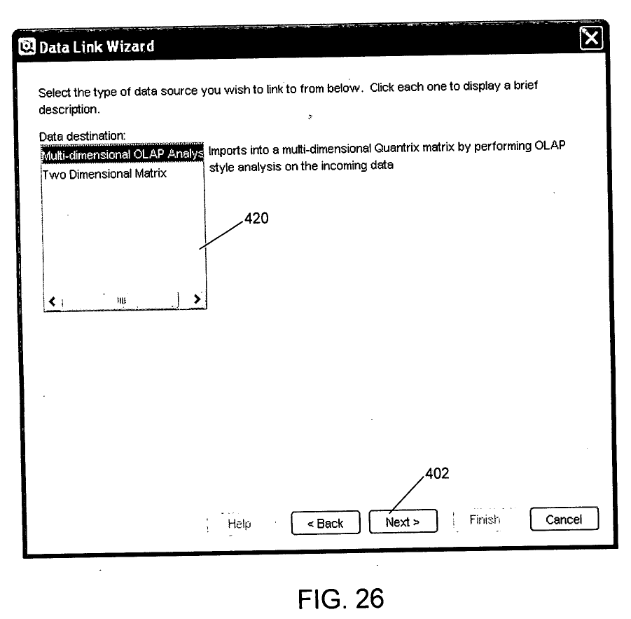

FIG. 26 illustrates the outcome of performing the step of clicking on the Next button 402 of FIG. 25. The screen of FIG. 26 includes data destination options window 420, which lists two formats for the selected data to be integrated into the matrix under development. The two destination formats listed are Multi-dimensional OLAP Analysis and Two Dimensional Matrix. More formats are possible. The user selects from the list the desired format of data to be included in a model and then clicks on the Next button 402 to proceed to the next Data Link Wizard interactive screen. For complex modeling involving more than two categories of information, the user should select the Multi-dimensional OLAP Analysis form to take full advantage of all features of the model building function 210 previously described.

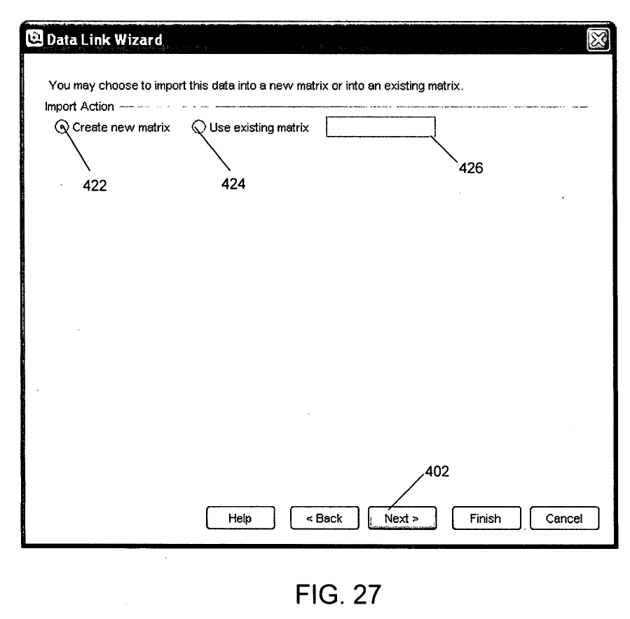

FIG. 27 illustrates the outcome of performing the step of clicking on the Next button 402 of FIG. 26 after having selected the Multi-dimensional format for the data previously identified in FIGS. 24 and 25. The interactive screen of FIG. 27 provides the user with the opportunity to import the reconfigured selected data into a new matrix under development by clicking on first button 422. Alternatively, the user may import the reconfigured data into an existing matrix, which may or may not be under development, by clicking on second button 424. If the second button 424 has been selected, the user will be prompted to select an existing matrix from a listing of saved matrices listed in matrix names bar 426. Clicking on the Next button 402 begins the process of enabling the user to organize the selected data sets into types, either as an item (forming part of the matrix itself) or as a category (setting the bounds of the items).

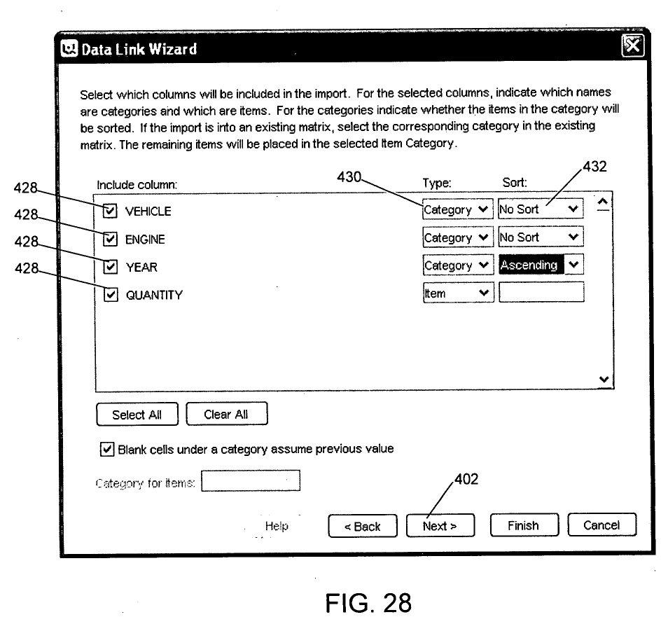

FIG. 28 illustrates the outcome of performing the step of clicking on the Next button 402 of FIG. 27 after having selected the option of integrating the selected and reconfigured data into a new matrix under development. The interactive screen of FIG. 28 provides the user with the opportunity to arrange initially the format of the matrix by category tiles and items. Specifically, the screen of FIG. 28 includes a check box 428 for each of the designate data sets (Vehicle, Engine, Year and Quantity). The default is for the check boxes to be selected. Unselecting any check box will remove from the matrix presentation initially created any indication of the data associated with that check box.

The screen of FIG. 28 also includes for each selected data set a type bar 430 and a sort bar 432. The user may select from Item and Category the form of the selected data set. For example, in the screen of FIG. 28, data sets Vehicle, Engine and Year have been selected for designation as categories. As a result, they will be represented as category tiles in either the row or column trays of the matrix under development. On the other hand, the Quantity data set has been selected for designation as an item type. As a result, the information of that data set will be integrated into the matrix as items within cells of the matrix, organized by the designated category tiles. The sort bar 432 permits the user to designate the sorting of the selected data types as either no sorting form, or ascending or descending form. Clicking on the Next button 402 begins the process of creating the matrix using the selected data sets in the arrangements designated through the interactive screen of FIG. 28.

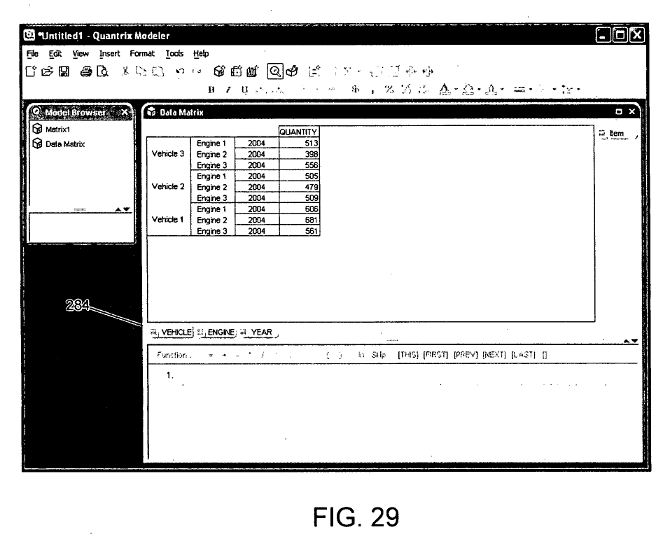

FIG. 29 illustrates the outcome of performing the step of clicking on the Next button 402 of FIG. 28 after having selected the arrangement of the matrix under development. It can be seen from the screen of FIG. 29 that the data types designated as Category are located in the row tray 284, with the Quantity data sets in the cells of the matrix as an Item set. The selected data which had been disorganized in the original data set as shown in FIG. 25, is shown organized in the selected format in FIG. 29. The matrix of FIG. 29 may be modified, reconfigured, expanded upon, etc. in the manner noted in describing the model building function 210 with respect to FIGS. 4-21.

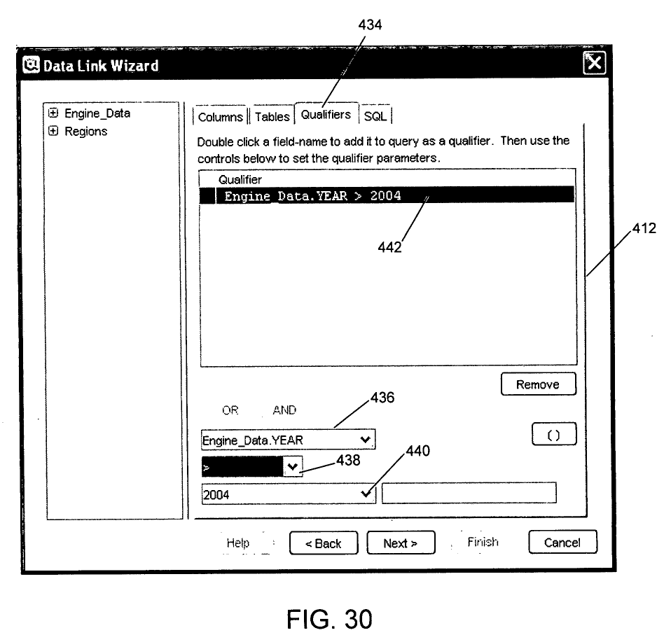

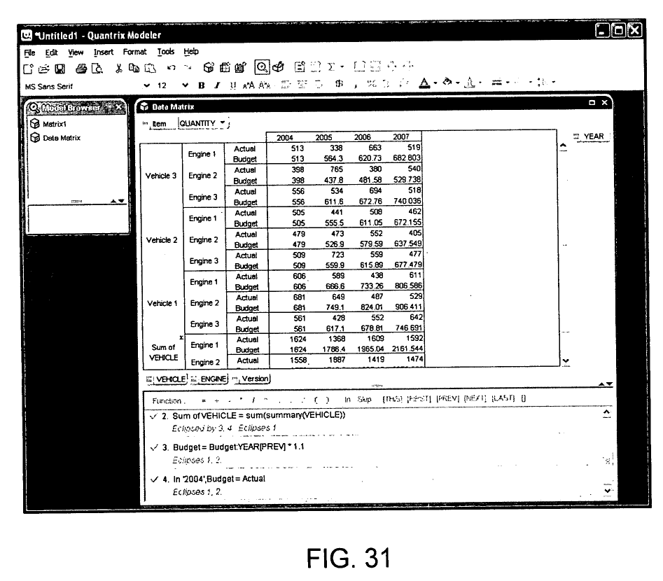

An optional feature of the data link function 220 is now described with respect to FIG. 30. Specifically, the user may return to the setup window 412 to establish qualifiers regarding one or more selected data sets to be integrated into the matrix under development. The user may click on qualifier tab 434 and be prompted to choose from a set bar drop down menu 436 one or more data sets to be qualified. The user is also prompted to select a qualification from a set of qualifiers listed in qualifier bar drop down menu 438. Further, the user is prompted to select a delimiter from a set of delimiters listed in delimiter bar drop down menu 440. The delimiters are established or customized by the user as a function of the particular data set selected for qualification. Double clicking on a selected data set with selected qualifier and delimiter activates the qualification, as represented by qualification listing 442. A plurality of qualifiers may be created. FIG. 31 illustrates the outcome of performing the step of adding as a qualifier that Engine data Year information is to be generated for years after 2004.

As previously noted, a complex model involving many data and/or or formulas increases the possibility of making errors in the application of particular cell and/or formula relationships. The dependency inspector function 230 of the system 200 reduces the difficulty of detecting where an error exists within the scheme of a complex multi-dimensional model. Specifically, the dependency inspector function 230 enables the system user to click on a particular cell of a matrix to be examined and easily observe the one or more inputs used to produce the item located in that cell and where the item of that cell is used as an input to one or more other items in one or more other cells. That is, the dependency inspector function 230 allows the user to navigate the dependencies between calculated items to see the calculation flow through the model. This is of value to a user in detecting where modeling errors may occur. It is also of value to those interested in auditing a model to confirm that formulas were appropriately selected and applied for example, and/or that the appropriate information was input into the calculations performed.

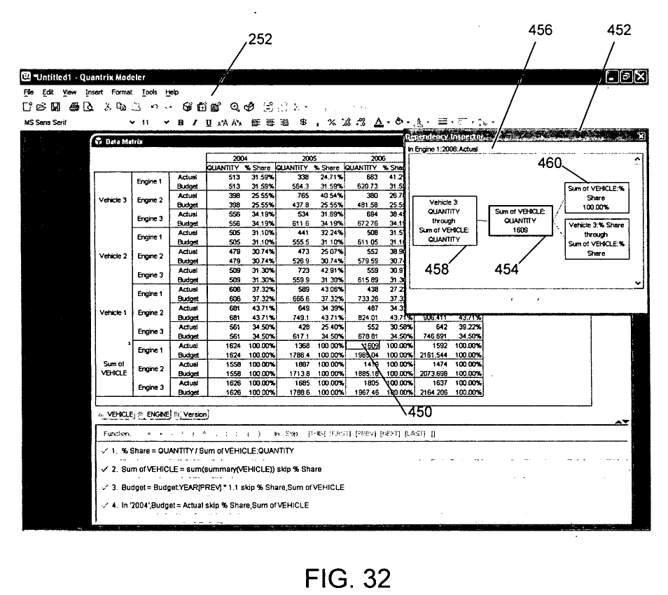

The dependency inspector function 230 is opened by clicking through to the Tools>Dependency Inspector tool of the menu bar 252. Prior to doing so, the user must click on and highlight a cell including an item the user wish to evaluate for dependency in relation to other items and/or calculations. FIG. 32 illustrates the outcome of performing the steps of selecting a cell 450 having an item of interest and clicking the tool on the menu bar 252 to activate the dependency inspector function 230. The result is the creation of a dependency inspector window 452.

The dependency inspector window 452 provides the user with a convenient means to view the content of cell 450 in an expanded focus cell 454. In the example matrix of FIG. 32, cell 450 only lists the item as a number. The expanded focus cell 454 indicates that the number is specifically the SUM of Vehicle Quantity item. Further, information bar 456 of the dependency inspector window 452 provides additional information about the cell item. That information for the example is the particular Engine type and the Year of Actual Sales associated with that Engine type. The dependency inspector window 452 further includes a precedent section 458 and a dependent section 460. The precedent section 458 includes one or more precedent input cells including detailed information of input to the expanded focus cell 454. The dependent section 460 includes one or more dependent output cells including detailed information of the items having as input the information of the expanded focus cell 454.

When the particular cell of interest is no longer highlighted, the dependency relationships drop away on the display. The dependency inspector function 230 further includes a subfunction to present the focus cell 454 cell in the middle of the display, a subfunction to permit the user to navigate forward and backward through the dependency pathway and all cells of the matrix. In this way, a user can detect whether a given cell dependency is as intended and, if not, correct that dependency, such as by changing cell relationships, changing formula selections for that cell, or a combination of the two.

The architecture of the system 200 of the present invention enables the advantages of relational analysis through the dependency inspector function 230. That architecture allows the user to view each cell, which with the conventional naming structure, is easily understood. The relationships among cells may be captured through programming arranged to detect dependency nodes. In turn, each set of adjacent cells may be sliced for inspection through recognition of adjacent nodes of the matrix.

In more general terms, the dependency inspector function 230 enables the configuration of dependency trees, in which dependencies and subdependencies may be viewed on the display on a scale greater than a focus cell and its immediately adjacent precedent and dependent cell(s) relationships. Further, the dependency inspector function 230 enables the user to change logic represented by formulas as well as dependencies by category, and to scale a model without repeating data entry, category generation, or formula creation. That capability is directly related to the architecture of the system 200, wherein the structure, logic and presentation are not linked. It is also to be noted that the dependency inspector function 230 may be used to produce one or more outputs of representations of one or more dependency relationships for examination using something other than a display of a computer system. For example, the dependency inspector function 230 may output such dependency information from one computing device to another or within a computing system without making it available for viewing on the display. Therefore, the presentation of dependency relationships on a computer display is optional.

These and other advantages of the data link function 220 and the dependency inspector function 230 derive the architecture of the system 200 embodied in a calculation engine. The calculation engine is a computer program arranged and configured to compose a model comprising one or more matrices. Each matrix is a multi-dimensional cube defined by a plurality of categories represented through the category tiles previously described. The number of dimensions of the multi-dimensional matrix is determined by the number of categories of items. The categories are named using understandable words or phrases. This category naming convention represents the structure of a matrix of a model and is an aspect of the operation of the calculation engine. Further, this construct allows each item of a model to be identified uniquely by its matrix and category naming, and not by a specific alphanumeric cell designation. As a result, an addressing scheme is established that is associated with the item name rather than the cell designation. The calculation engine performs operations through item name representations rather than cell designations.

Another aspect of the operation of the calculation engine is the logic. The logic of the system 200 is represented by the formulas used to perform calculations on selectable items, including individual items within single cells, as well as swaths of items across a plurality of selectable cell sets. Examples of formulas generated through the calculation engine are formulas 316, 318, and 320 of FIG. 4 and following figures. Each formula includes a left side and a right side related to one another by an equal sign. The left side of the formula defines the range of the matrix, or more particularly, the specific category or section of a category, upon which a calculation is to be performed. In a conventional spreadsheet modeler, the only thing on the left side is an alphanumeric cell designation. The system 200 of the present invention allows the user to define any range of items to be calculated. The right side of the formula comprises an arbitrary expression representing the calculation to be performed. A simple example of a formula including a left side and a right side is formula 320 of FIG. 4.

The calculation engine of the system 200 of the present invention further enables the user to constrain the range of items to be calculated in one or more of several ways. First, the user may constrain the left side of a formula to calculate a portion of a set of items. This is achieved using an IN instruction to specify an inclusive, contiguous range to adjust the scope of what may otherwise be a generic formula. Second, the user may constrain the right side of a formula to calculate a portion of a set of items. This is achieved using a SKIP instruction to exclude one or more categories or items to adjust the scope of what may otherwise be a generic formula. The IN and SKIP instructions enable the user to create a generic formula and employ it in different situations, wherein the constraints defined by the IN and SKIP instructions ensure that the formula is applicable for a particular set of items of interest.

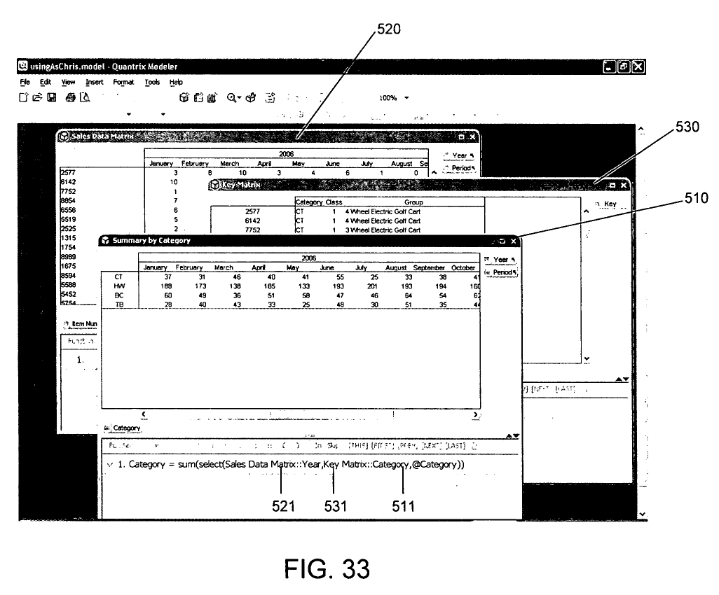

A third constraint instruction available to the user of the system 200 of the present invention is the USING AS instruction. FIG. 33 illustrates the outcome of performing the step of creating a formula including the USING AS instruction as a constraint. The USING AS instruction enables the user to constrain and simplify a formula by coding the formula to coding associated with a set of data. The USING AS function employs three arguments, a Value List, a Key List, and a Lookup Value. The Value List establishes a range of values to be obtained for use in the calculation performed through the formula. The Key List defines the keys or codes associated with the values of the Value List. The Lookup Value is the particular item of the Value List to be selected from the item set defined by the codes of the Key List for use in the formula.

The screen of FIG. 33 shows formula 500 including the USING AS function. Matrix 510 is the resultant matrix generated by the operation of formula 500. It can be seen that Matrix 510 includes the representation of a summary of sales of items of a category within the specified Year 2006 by month. The summary of Matrix 510 was generated using information from Sales Data Matrix 520 and Key Matrix 530. Argument 521 of formula 500 is the Value List and constrains formula 500 to obtain from the Sales Matrix 520 the items as defined by Key List argument 531 designated in the Key Matrix 530. Argument 511 of formula 500 defines the arrangement of the items of the Sales Matrix 520 to be represented in Matrix 510. It can be seen that the USING AS instruction enables the user to integrate the information from one matrix with another, particularly when one of the two matrices has a relatively static item set, which may be the Key List. The USING AS instruction enables value and dimensional mapping across matrices, thereby making any formula more powerful and easier to use.

The understandable category/item naming and left side/right side formula configuration enable the calculation engine of the system 200 to integrate data of different types with one another into a common set of items by selectable category descriptions. Moreover, doing so allows the user to add new sets of data to existing matricies without requiring a complete re-creation of any matrix. It also allows the use of existing formulas without generating new ones or revising existing formulas without re-configuring them to accommodate new data sets. These features make the data link function 220 particularly effective in combination. In addition, the understandable naming of categories/items and the formula arrangement enable the dependency inspector function 230 to provide specific information of the predecessor and successor dependency of each item of any matrix of the model, including across matrices and across models.

The calculation engine enables dependency inspector functionality by establishing cell slices. Each cell slice may be defined by a formula comprising a left side and a right side and, optionally constraints of the type described herein. The formula may be generated by the user or it may be inherent. An item of specified value may have an inherent formula if it is fixed. For example, in the case of a cell having the information “10” representing the number of Engines of Type 1 sold in month March of Year 1, the formula may inherently be Engine Type 1 sold in March Year 1=10. As a result of this use of a left side/right side formula logic, the relationship among all cells can be determined and presented. A first cell of a dependency relationship to be presented may be defined as the zero cell. A slice offset of cells immediately adjacent to that cell may be determined, noting that the cell value represents all or a portion of the right side of the equation for the first offset successor cell, and that the same cell value represents all or a portion of the left side of an equation of one or more immediately adjacent predecessor cells. It is to be understood that an immediately adjacent cell is not limited to cells contiguous physically to the cell, but rather those cells having a direct input to output from that cell. It can be a physically adjacent cell or a cell from a different matrix. This offset cell slicing may be performed for all cells of all matrices of a model. When the particular input cell(s) to a cell of interest and output cell(s) using the information of that cell of interest are identified, they may be presented to the user through the presentation function 240 and the dependency inspector function 230, as shown by example in FIG. 32.

Other variations of the above examples can be implemented. One example variation is that the process for creating the model may include additional steps. Further, the order of the steps forming the process is not limited to the order described, as the steps may be performed in other orders, and one or more steps may be performed in series or in parallel to one or more other steps, or parts thereof. Additionally, the processes, steps thereof and various examples and variations of these processes and steps, individually or in combination, may be implemented as a computer program product tangibly as computer-readable signals on a computer-readable medium, for example, a non-volatile recording medium, an integrated circuit memory element, or a combination thereof. Such computer program product may include computer-readable signals tangibly embodied on the computer-readable medium, where such signals define instructions, for example, as part of one or more programs that, as a result of being executed by a computer, instruct the computer to perform one or more processes or acts described herein, and/or various examples, variations and combinations thereof. Such instructions may be written in any of a plurality of programming languages as previously noted.

A number of examples to help illustrate the invention have been described. Nevertheless, it will be understood that various modifications may be made without departing from the spirit and scope of the invention. Accordingly, other embodiments are within the scope of the claims appended hereto.

What is claimed is:

1. A system for modeling one or more outcomes based on input information on a computer system, the system comprising:
a. a model building function, the model building function arranged to generate one or more multi-dimensional matrices containing the input information and calculated information, wherein the calculated information is obtained using one or more of formulas, assumptions, and/or input information, each of the one or more matrices including a plurality of cells of input information and calculated information; and
b. a data link function, the data link function arranged to configure external information into a selectable format for introduction into any of the one or more matrices and selectable calculation of calculated information therefrom.

2. The system as claimed in claim 1 further comprising a dependency inspector function, wherein the dependency inspector function is arranged to determine and make available for review the dependency of a particular cell of any of the one or more matrices on one or more other cells of any of the one or more matrices.

3. The system as claimed in claim 1 wherein the data link function includes a source configuration subfunction to configure the external information into a selectable type, and a destination configuration subfunction to configure any of the one or more matrices into a selectable type for entering the configured external information.

4. The system as claimed in claim 3 wherein the selectable type of the source configuration subfunction is selected from the group consisting of Delimited Text File, JDBC/ODBC Data Source, Two Dimensional Data Matrix, Web Services (SOAP), and XML Data Source.

5. The system as claimed in claim 4 wherein the selectable type of the destination configuration subfunction is selected from the group consisting of a two-dimensional matrix and a multidimensional matrix.

6. The system as claimed in claim 1 comprising an architecture including a logic aspect, a structure aspect and a presentation aspect, wherein the logic aspect, the structure aspect and the presentation aspect can each be manipulated without affecting the other aspects.

7. The system as claimed in claim 1 wherein the model building function includes an arrangement for naming categories of information and items of information using understandable language.

8. The system as claimed in claim 1 further comprising a calculation engine of the model building function arranged to create and apply one or more formulas.

9. The system as claimed in claim 8 wherein the calculation engine includes a USING AS formula syntax.

10. The system as claimed in claim 8 wherein any of the one or more formulas of one of the one or more matrices may perform calculations using information from one or more other matrices.

11. The system as claimed in claim 8 wherein any single one of the one or more formulas may be used to calculate calculated information across a range of the plurality of cells of any of the one or more matrices.

12. The system as claimed in claim 1 wherein the computer system includes a display, the system further comprising a presentation function arranged to display on the display of the computer system the one or more matrices, and further arranged to enable a user to manipulate the appearance of the one or more matrices on the display.

13. The system as claimed in claim 12 wherein categories of information are represented as category tiles of the one or more matrices.

14. The system as claimed in claim 13 wherein the model building function enables manipulation of the positioning of any category tile on any of the one or more matrices within and across matrices without requiring re-introduction of the input information or the calculated information.

15. The system as claimed in claim 12 wherein the model building function includes a filtering function to enable a change in the presentation of the input information and calculated information of any of the one or more matrices without requiring re-introduction of any of the input information or calculated information.

16. A system for modeling one or more outcomes based on input information on a computer system, the system comprising:
a. a model building function, the model building function arranged to generate one or more multi-dimensional matrices containing the input information and calculated information, wherein the calculated information is obtained using one or more of formulas, assumptions, and/or input information, each of the one or more matrices including a plurality of cells of input information and calculated information; and
b. a dependency inspector function, the dependency inspector function arranged to determine and make available for review the dependency of a particular cell of any of the one or more matrices on one or more other cells of the one or more matrices.

17. The system as claimed in claim 16 further comprising a data link function, the data link function arranged to configure external information into a selectable format for introduction into any of the one or more matrices and selectable calculation of calculated information therefrom.

18. The system as claimed in claim 17 wherein the data link function includes a source configuration subfunction to configure the external information into a selectable type, and a destination configuration subfunction to configure any of the one or more matrices into a selectable type for entering the configured external information.

19. The system as claimed in claim 18 wherein the selectable type of the source configuration subfunction is selected from the group consisting of Delimited Text File, JDBC/ODBC Data Source, Two Dimensional Data Matrix, Web Services (SOAP), and XML Data Source.

20. The system as claimed in claim 19 wherein the selectable type of the destination configuration subfunction is selected from the group consisting of a two-dimensional matrix and a multidimensional matrix.

21. The system as claimed in claim 16 comprising an architecture including a logic aspect, a structure aspect and a presentation aspect, wherein the logic aspect, the structure aspect and the presentation aspect can each be manipulated independently without affecting other aspects.

22. The system as claimed in claim 16 wherein the model building function includes an arrangement for naming categories of information and items of information using understandable language.

23. The system as claimed in claim 16 further comprising a calculation engine of the model building function arranged to create and apply one or more formulas.

24. The system as claimed in claim 23 wherein any of the one or more formulas of one of the one or more matrices may perform calculations using information from one or more other matrices.

25. The system as claimed in claim 23 wherein any single one of the one or more formulas may be used to calculate calculated information across a range of the plurality of cells of any of the one or more matrices.

26. The system as claimed in claim 23 wherein the calculation engine includes a USING AS formula syntax.

27. The system as claimed in claim 23 wherein each of the one or more formulas includes a modifiable left side and a modifiable right side.

28. The system as claimed in claim 27 wherein the dependency inspector function is configured to detect one or more cell inputs to a selectable cell of any of the one or more matrices and one or more cell outputs from the selectable cell based on information from the left side and the right side of any formulas including the selectable cell.

29. The system as claimed in claim 16 wherein the computer system includes a display, the system further comprising a presentation function arranged to display on the display of the computer system the one or more matrices, and further arranged to enable a user to manipulate the appearance of the one or more matrices on the display.

30. The system as claimed in claim 29 wherein categories of information are represented as category tiles of the one or more matrices.

31. The system as claimed in claim 30 wherein the model building function enables manipulation of the positioning of any category tile on any of the one or more matrices within and across matrices without requiring re-introduction of the input information or the calculated information.

32. The system as claimed in claim 29 wherein the model building function includes a filtering function to enable a change in the presentation of the input information and calculated information of any of the one or more matrices without requiring re-introduction of any of the input information or calculated information.

33. A system for modeling one or more outcomes based on input information on a computer system including a display, the system comprising:
a model building function, the model building function arranged to generate one or more multi-dimensional matrices containing the input information and calculated information, wherein the calculated information is obtained using one or more of formulas, assumptions, and/or input information, each of the one or more matrices including a plurality of cells of input information and calculated information, and wherein the model building function includes a calculation engine arranged to create and apply one or more formulas, wherein the calculation engine includes a USING AS formula syntax.

34. The system as claimed in claim 33 further comprising a dependency inspector function arranged to determine and make available for review the dependency of a particular cell of any of the one or more matrices on one or more other cells of any of the one or more matrices.

35. The system as claimed in claim 34 further comprising a data link function arranged to configure external information into a selectable format for introduction into any of the one or more matrices and selectable calculation of calculated information therefrom.

36. The system as claimed in claim 33 further comprising a data link function arranged to configure external information into a selectable format for introduction into any of the one or more matrices and selectable calculation of calculated information therefrom.

37. The system as claimed in claim 36 wherein the data link function includes a source configuration subfunction to configure the external information into a selectable type, and a destination configuration subfunction to configure any of the one or more matrices into a selectable type for entering the configured external information.

38. The system as claimed in claim 37 wherein the selectable type of the source configuration subfunction is selected from the group consisting of Delimited Text File, JDBC/ODBC Data Source, Two Dimensional Data Matrix, Web Services (SOAP), and XML Data Source.

39. The system as claimed in claim 38 wherein the selectable type of the destination configuration subfunction is selected from the group consisting of a two-dimensional matrix and a multidimensional matrix.

40. The system as claimed in claim 33 wherein the computer system includes a display, the system further comprising a presentation function arranged to display on the display of the computer system the one or more matrices, and further arranged to enable a user to manipulate the appearance of the one or more matrices on the display.
